(19) United States
(12) Patent Application Publication
(10) Pub. No.: US 2023/0148612 A1
(43) Pub. Date: May 18, 2023

(54) WATER-BASED INSECTICIDAL AND INSECT REPELLENT COMPOSITIONS

(71) Applicant: S. C. Johnson & Son, Inc., Racine, WI (US)

(72) Inventor: Alexis Huckabee, Kenosha, WI (US)

(21) Appl. No.: 17/989,565

(22) Filed: Nov. 17, 2022

Related U.S. Application Data
(60) Provisional application No. 63/280,994, filed on Nov. 18, 2021.
(60) Provisional application No. 63/280,997, filed on Nov. 18, 2021.

(51) Int. Cl. A01N 65/22; A01N 65/34; A01N 65/24; A01N 65/12; A01N 25/02; A01N 25/30

(52) U.S. Cl. CPC A01N 65/22; A01N 65/34; A01N 65/24; A01N 65/12; A01N 25/02; A01N 25/30

(57) ABSTRACT

A pest control composition that includes an active component having between about 0.001 wt. % and about 10 wt. % of spearmint oil, between about 0.01 wt. % and about 10 wt. % of geranium oil, and between about 0.01 wt. % and about 10 wt. % of a third oil. The composition further includes a solvent, a carrier, and a surfactant, and the third oil may be cinnamon oil, cedarwood oil, and mixtures thereof.

### CROSS REFERENCE TO RELATED APPLICATIONS

This application is related to, claims priority to, and incorporates herein by reference for all purposes U.S. Provisional Patent Application No. 63/280,994, filed Nov. 18, 2021, and U.S. Provisional Patent Application No. 63/280,997, filed on Nov. 18, 2021.

### REFERENCE REGARDING FEDERALLY SPONSORED RESEARCH OR DEVELOPMENT

Not applicable.

### SEQUENCE LISTING

Not applicable.

### BACKGROUND

### 1. Technology Field

The present disclosure relates to a pest control composition and, more particularly, to a water-based insecticidal composition including (i) mint oil (e.g., spearmint oil, cornmint oil, and mixtures thereof), and (ii) geranium oil. The present disclosure also relates to a pest control composition including (i) eugenol, (ii) water, and (iii) a solvent (e.g., ethyl lactate, butyl lactate, isopropyl alcohol, isopropyl myristate, and mixtures thereof).

### 2. Description of the Background

Pest Control compositions, including insecticide compositions have been used over the years to prevent insects from attacking humans, animals, and crops. A majority of insecticides in the market use oil-based organic solvents (e.g., mineral oil or other petroleum-based solvents) as a carrier in their products as most active ingredients that kill and/or repel insects are readily soluble in oil-based organic solvents. However, potential disadvantages of employing oil-based organic solvents in insecticide and insect repellent compositions include the unpleasant, harsh, and lingering chemical odor typical of common oil-based organic solvents (e.g. mineral oil or other petroleum-based solvents).

Therefore, it is desirable to have a pest control composition, including an insecticidal or an insect repellent composition that reduces the unpleasant, harsh, and lingering chemical odor and at the same time does not sacrifice the efficacy of the composition.

### SUMMARY

Embodiments of the current disclosure describe a pest control composition that includes an active component consisting of spearmint oil, geranium oil and a third oil (e.g., cinnamon oil, cedarwood oil, or combinations thereof). In the present disclosure, Applicant demonstrates that a combination of the mint and geranium essential oils unexpectedly provides a pleasant smell, a low linger scent, and a high efficiency of killing/repelling insects.

In some embodiments, the composition can include between about 0.001 wt. % and about 10 wt. % of spearmint oil, between about 0.01 wt. % and about 10 wt. % of geranium oil, between about 0.01 wt. % and about 10 wt. % of a third oil selected from the group consisting of cinnamon oil, cedarwood oil, and mixtures thereof. In this embodiment, the composition further includes a solvent, a carrier, and a surfactant, and all weight percentages are percent by weight of the total composition.

In some embodiments, the weight ratio of geranium oil to spearmint oil is from about 0.5:1 to about 20:1. In further embodiments, the weight ratio of geranium oil to spearmint oil is from about 0.8:1 to about 18:1. In other embodiments, the weight ratio of geranium oil to spearmint oil is from about 1:1 to about 16:1. In particular embodiments, the solvent comprises at least one of ethyl lactate, butyl lactate, isopropyl alcohol, isopropyl myristate, and combinations thereof. In some embodiments, the carrier is water. In still further embodiments, the surfactant is selected from the group consisting of lecithin, sodium lauryl sulfate, sodium oleate, potassium oleate, sodium ricinolate, Quillaja saponin, polyglyceryl oleate, glyceryl monooleate, and any combinations thereof.

In certain embodiments, the composition comprises between 15% and about 30% by weight of the solvent; between 55 wt. % and about 85 wt. % of the carrier; between about 1 wt. % and about 4.5 wt. % of the surfactant; between about 1% to about 5% of a propellant and between about 0.1% to about 0.5% by weight of a preservative. Additionally, in some embodiments, the propellant is selected from the group consisting of compressed gas propellants, liquefied gas propellants, saturated hydrocarbons, mixtures of liquified gas and compressed gas, In certain embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In particular embodiments, the mint oil is in a higher weight percentage concentration than the geranium oil.

According to another embodiment of the present disclosure, another pest control composition is provided. In this embodiment, the pest control composition includes an active component including between about 0.001 wt. % and about 10 wt. % of at least one mint oil, between about 0.01 wt. % and about 10 wt. % of geranium oil, and between about 0.01 wt. % and about 10 wt. % of cinnamon oil. In this embodiment, the composition further includes a carrier, a solvent, and a surfactant, and all weight percentages are percent by weight of the total composition. In some embodiments, the mint oil is selected from the group consisting of spearmint oil, peppermint oil, cornmint oil, and combinations thereof. In particular embodiments, the mint oil is spearmint oil.

In one embodiment, the composition comprises between 15% and about 30% by weight of the solvent; between 55 wt. % and about 85 wt. % of the carrier; between about 1 wt. % and about 4.5 wt. % of the surfactant; between about 1% to about 5% of a propellant and between about 0.1% to about 0.5% by weight of a preservative. In another embodiment, the weight ratio of geranium oil to mint oil is from about 0.5:1 to about 20:1.

In certain embodiments, the carrier includes water. In some embodiments, the solvent is selected from the group consisting of ethyl lactate, butyl lactate, isopropyl alcohol, isopropyl myristate, and combinations thereof. In other embodiments, the surfactant is selected from the group consisting of lecithin, sodium lauryl sulfate, sodium oleate, potassium oleate, sodium ricinolate, Quillaja saponin, polyglyceryl oleate, glyceryl monooleate, and any combinations thereof. In some embodiments, the propellant is selected from the group consisting of methane ethane, propane, pentane, isobutene, n-butane, isobutane, dimethyl ether, 1, 1-difluoroethane, 1,1,1,2-tetrafluoroethane, carbon dioxide, nitrogen, air, and any combinations thereof.

According to yet another embodiment of the present disclosure, another pest control composition is provided. In this embodiment, the pest control composition includes an active component that includes between about 0.001 wt. % and about 5 wt. % of a mint oil selected from the group consisting of spearmint oil, cornmint oil, and mixtures thereof, between about 0.01 wt. % and about 5 wt. % geranium oil, and between about 0 wt. % to about 5 wt. % of an oil selected from the group consisting of cinnamon oil, cedarwood oil, and mixtures thereof. This embodiment further includes about 55 wt. % to about 86 wt. % of water. In certain embodiments, the composition further includes about 3 wt. % to about 15 wt. % at least one solvent. In particular embodiments, the composition includes about 1 wt. % to about 5 wt. % at least one surfactant, In this embodiment, the composition further includes about 1 wt. % to about 5 wt. % of at least one propellant. In some embodiments, a weight ratio of geranium oil to mint oil is from about 0.5:1 to about 20:1, and all weight percentages are percent by weight of the total composition.

### DETAILED DESCRIPTION

The term “about” or “approximately” means within an acceptable error range for the particular value as determined by one of ordinary skill in the art, which will depend in part on how the value is measured or determined, i.e., the limitations of the measurement system, i.e., the degree of precision required for a particular purpose, such as a pharmaceutical formulation. The term “about” refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture.

In one embodiment, the term “about” refers to a range of values+/−5% of a specified value. For example, “about” can mean within 1 or more than 1 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

The term “substantially,” as used herein, means at least about 80%, preferably at least about 90%, more preferably at least about 99%, for example at least about 99.9%. In some embodiments, the term “substantially” can mean completely, or about 100%.

The term “weight percent”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Embodiments of the invention can be used to control parasites. The term “parasite” encompasses numerous protozoa, helminths, and ectoparasites. Protozoa may include the ameba, flagellates, ciliates, and the sporozoa. Protozoa typically infect the blood and tissue and may be transmitted through the bite of a mosquito. Protozoa are responsible for such diseases as malaria, trypanosomiasis, leishmaniasis, toxoplasmosis, and cryptosporidiosis. Helminths are typically classified into three groups, flatworms, roundworms, and thorny-headed worms. Helminths are responsible for such diseases as enterobiasis, ascariasis, taeniasis, cysticercosis, and schistosomiasis. Ectoparasites may include mosquitoes, ticks, fleas, lice, and mites. Many ectoparasites may cause disease on their own, but are even more important as vectors of a number of different pathogens, including protozoa.

Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object or insect breeding site treated with said composition. In some embodiments, as will be shown in the present disclosure, a repellent effect is an effect wherein at least about 75% of insects are repelled away from a host or area that has been treated with the composition. In some embodiments, however, a repellent effect is an effect wherein at least about 90% of insects are repelled away from a host or area that has been treated with the composition. In addition, “pesticidal effect” is an effect wherein treatment with a composition causes at least about 1% of the insects to die. In this regard, an LC1 to LC100 (lethal concentration) or an LD1 to LD100 (lethal dose) of a composition will cause a pesticidal effect. In some embodiments, the pesticidal effect is an effect wherein treatment with a composition causes at least about 5% of the exposed insects to die. In some embodiments, the target pest is a non-insect, such as a parasite.

As used herein, the term “knocking down” or “knockdown” refers to the ability of the composition described herein to render an insect immobile. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease or irritate is severely curtailed during the period in which it is knocked down.

As used herein, the term “killing” or “kill” refers to the ability of at least one active ingredient in a composition to render an insect dead. As further used herein, the term “knocking down” or “knockdown” refers to the ability of the composition described herein to render an insect immobile for a pre-determined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

In the pest control field, it is known that consumers desire a product that has a reduced unpleasant, harsh, and lingering chemical odor. Therefore, it is important to develop a pest control composition that offers a pleasant fragrance experience and does not compromise the insect killing/repelling efficacies. It has been found that a pest control composition comprising mint oil and geranium oil provides such benefits. It has also been found that a pest control composition comprising eugenol, water, and a solvent provides such benefits.

The compositions described herein present novel combinations of essential oil active ingredients and/or other components that result in an improved pest control composition offering consumers a dual action experience and pleasant low lingering hedonics without sacrificing efficacy. The pleasant fragrance experience allows the user to spray the pests in a room and remain in the room following application of the composition. In the present disclosure, Applicant demonstrates that a combination of these essential oils unexpectedly provides a pleasant smell, a low linger scent, and is highly efficacious in killing insects. In particular, the pest control composition described herein causes pest mortality in small to large bugs by at least weakening pest's exoskeleton and/or obstructing pest's central nervous system, resulting in a pest knockdown rate as much as 88% in 30 seconds, and a pest mortality rate as much as 100% in 24 hours.

The pest control composition according to an embodiment of the present disclosure is a composition comprising (i) mint oil (e.g., spearmint oil, cornmint oil, and mixtures thereof) and (ii) geranium oil. The pest control composition according to another embodiment of the present disclosure is a composition comprising (i) eugenol, (ii) water, and (iii) a solvent (e.g., ethyl lactate, butyl lactate, isopropyl alcohol, isopropyl myristate, and combinations thereof). The pest control composition according to another embodiment of the present disclosure is a composition comprising (i) eugenol and (ii) a first solvent consisting of butyl lactate.

In certain embodiments, the pest control compositions include an active component and an additional component. In some embodiments, the active component includes one or more essential oils, such as at least mint oil and geranium oil. The compositions of the present disclosure may also include one or more additional components. In other embodiments, for example, the compositions of the present disclosure may include a carrier, a solvent, a surfactant, a preservative, and/or a propellant.

In certain embodiments, the pest control composition includes (i) mint oil (e.g., spearmint oil, cornmint oil, and mixtures thereof), and (ii) geranium oil.

The total amount of the active component (e.g., the total amount of essential oils in the composition) may be from about 0.01 wt. %, or from about 0.05 wt. %, or from about 0.5 wt. %, or from about 1 wt. %, or from about 2 wt. %, or from about 2.5 wt. %, or from about 5 wt. %, or from about 6 wt. %, or from about 7 wt. %, or from about 8 wt. %, or from about 9 wt. %, or from about 10 wt. %, and to about 25 wt. %, or to about 22 wt. %, or to about 20 wt. %, or to about 17 wt. %, or to about 15 wt. %, or to about 12 wt. %, or to about 8 wt. %, or to about 6 wt. %, or to about 4 wt. %, or to about 3 wt. %, or to about 2.5 wt. %. In an embodiment, the total amount active component is present in an amount from about 0.05 wt. % to about 15 wt. %, or from about 0.5 wt. % to about 6 wt. %, or from about 1 wt. % to about 4 wt. %, or from about 2 wt. % to about 4 wt. %, wherein all weight percentages are percent by weight of the total composition. In an embodiment, the total amount active component is present in an amount from about 2.5 wt. % to about 3.5 wt. % wherein all weight percentages are percent by weight of the total composition. In an embodiment, the total amount active component is present in an amount of about 3 wt. % based on the total weight of the total composition.

Essential Oils. The pest control composition according to an embodiment of the present disclosure, is a composition that includes essential oils—e.g., at least one mint oil (e.g., spearmint oil, peppermint oil, and cornmint oil), geranium oil, rosemary oil, cinnamon oil, and/or cedarwood oil. In particular embodiments, the pest control composition includes essential oils of spearmint and geranium oil. In other embodiments, the pest control composition includes the essential oil eugenol.

Particular strains of certain essential oils may be especially well-suited for use in certain insecticidal or insect repellent formulations. Additionally, the essential oils help provide a synergistic effect when combined, and in further embodiments, when combined in particular ratios. In particular embodiments, the insecticidal or insect repellent formulations include at least one mint oil (e.g., spearmint oil, peppermint oil, cornmint oil) and geranium oil, cinnamon oil, and/or cedarwood oil.

Spearmint oil. For the purposes of this disclosure, as used herein, “spearmint oil” may refer to both extracted and synthetic versions of Mentha spicata, Mentha crispa, Mentha crispate, Mentha cardiaca G. (scotch spearmint), Mentha spicata L. var. crispa (Bentham) Danert (native spearmint), and/or Mentha viridis, and derivatives thereof. Spearmint is also known as garden mint, common mint, lamb mint, and mackerel mint. Spearmint may also be a species of mint and may be native to Europe and southern temperate Asia, extending from Ireland in the west to southern China in the east. Further, spearmint oil includes a CAS registry number of 8008-79-5. In addition, spearmint oil may have at least one of the following constituents: carvone, limonene, (Z)-Dihydrocarvone, menthone, β-myrcene, α-pinene, camphene, sabinene, β-pinene, myrcene, 3-octanol, p-cymene, 1,8-cineole, (Z)-β-ocimene, cis-sabinene hydrate, linalool, cis-p-menth-2-en-1-ol, cis-limonene oxide, trans-limonene oxide, borneol, δ-terpineol, 4-terpineol, α-terpineol, dihydrocarveol, cis-dihydrocarvone, trans-carveol, cis-carveol, pulegone, isobornyl acetate, iso-dihydrocarveol acetate, β-bourbonene, β-elemene, β-caryophyllene, germacrene D, germacrene A, spathulenol, caryophyllene oxide, monoterpene hydrocarbons, oxygenated monoterpenes, sesquiterpene hydrocarbons, and/or oxygenated sesquiterpenes. In particular embodiments, the spearmint oil may have at least the following constituents: carvone, limonene, (Z)-Dihydrocarvone, 3-octanol, menthone, 1,8-cineole, and 3-myrcene.

Peppermint oil. For the purposes of this disclosure, as used herein, “peppermint oil” may refer to both extracted and synthetic versions of Mentha balsamea Wild, Mentha x piperita L., and derivatives thereof. Peppermint can also be a hybrid mint—a cross between watermint and spearmint. Further, peppermint oil has the CAS registry number 8006-90-4, and may have at least one of the following constituents: menthol, menthone, menthyl acetate, 1,8-cineol, menthofuranne, neomenthol, isomenthone, beta-caryophyllene, germacrene D, limonene, β-pinene, terpinene-4-ol, α-pinene, (6R)-(+)-Menthofuran tr, terpinen-4-ol, (1R)-(+)-β-pulegone, germacrene, β-caryophyllene, (E)-sabinene hydrate, piperitone, and/or isomenthol. In particular embodiments, peppermint oil includes at least the following constituents: menthol, menthone, menthyl acetate, neomenthol, 1,8-cineole, (6R)-(+)-Menthofuran, isomenthone, terpinen-4-ol, (1R)-(+)-β-Pulegone, limonene, germacrene D, β-caryophyllene, (E)-Sabinene hydrate, β-pinene, piperitone, and isomenthol.

Cornmint oil. As used herein, “cornmint oil” may refer to both extracted and synthetic versions of Mentha arvensis, Mentha arvensis L., Mentha arvensis f. piperascens Malinv. Ex Holmes, Mentha arvensis L. var. galbrata Benth, Mentha arvensis L. var. villosa Benth, Mentha canadensis L., and derivatives thereof. Further, cornmint oil has a CAS registry number 68917-18-0. Cornmint is also known as field mint or wild mint. Further, like spearmint oil and peppermint oil, cornmint oil is a species of flowering plant in the mint family Lamiaceae. Cornmint oil may also have at least one of the following constituents: cis-beta-ocimene, β-phellandrene, gamma-terpinene, terpinolene, α-pinene, neomenthol, santene, α-thujene, p-cymene, β-farnesene, β-caryophyllene, betabourbonene, myrcene, β-myrcene, α-terpinene, delta-terpinene, limonene, β-pinene, camphene, sabinene, germacrene D, gamma-caryophyllene, delta-cardinene, ethanol, 3-methylbutanol, 3-octanol, citronellolnerol, menthol, isomenthol, α-terpineol, isopulegol, cis-carveol, pmenthan-2,5-diol, isocaryophyllenol, butanol, (Z)-3-hexenol, 2,6-nonadienol, geraniol, neoisomenthol, terpinen-4-ol, neoiso(iso)pulegol, trans-carveol, borneol, viridiflorol, acetaldehyde, 3-methylbutanal, geranial, 2-methylpropanal, 2,6-nonadienal, neral, acetone, 2-heptanone, 2-isopropylcyclopentanone, 3-methylcyclohexanone, menthone, piperitone, carvone, 2-butanone, methylheptenone, cis-jasmone, carvomenthone, isomenthone, pulegone, (1R)-(+)-β-pulegone, iso-isopulegol, formic acid, 3-methylbutanoic acid, hexanoic acid, nonanoic acid, acetic acid, pentanoic acid, (E)-2-hexenyl acetate, (Z)-3-hexenyl acetate, l-octen-3-yl acetate, geranyl acetate, linalyl acetate, menthyl acetate, isomenthyl acetate, neomenthyl acetate, neoisomenthyl acetate, dihydrocarvyl acetate, (Z)-3-hexenyl 3-methylbutanoate, menthyl 3-methylbutanoate, menthyl pentanoate, (Z)-3-hexenyl hexanoate, menthyl hexanoate, (Z)-3-hexenyl 2-hydroxybenzoate, (E)-2-hexenyl phenylacetate, (Z)-3-hexenyl phenylacetate, 3-phenylpyridine, 3-phenyl-4-propylpyridine, menthofuran, menthofurolactone, 1,8-cineole, trans-2,5-diethylfuran, 3-(5,5-dimethyltetrahydro-2-furyl)-(Z)-2-butenol-1, piperitone oxide, beta-caryophyllene oxide, and/or 2-isopropyl-5-methylphenol (thymol). In particular embodiments, cornmint oil may include the following major constituents: menthol and menthone.

Geranium oil. As used herein, “geranium oil” refers to both extracted and synthetic oils of geranium, and derivatives thereof. Geranium is a genus of 422 species of annual, biennial, and perennial plants that are commonly known as geraniums or cranesbills. Geranium oil has the CAS registry number 8000-46-2 and at least one of the following constituents: citronellol, geraniol, linalool, citronellyl formiate, menthone, geranyl-formiate, 3,7-gvaiedien, alpha-terpineol, izomenthon, beta-burbonen, tetrahydrogeraniol, alpha-pinene, geranyl-butyrate, linalyl-propionate, cis-rozokside, geranyl-tiglate, beta-caryophyllene, citronellyl-propionate, citronellyl-butyrate, calamenen, neryl-propionate, benzylidene camphor, geranyl-propionate, and/or delta-gvaien. In particular embodiments, geranium oil may include the following major constituents: Citronellol, Citronellyl formate, Geraniol, Guaia-6,9-diene, Isomenthone, Linalool, Menthone, Geranyl formate, (Z)-+(E)-Rose oxide, Germacrene, Geranyl tiglate, Citronellyl propionate, β-Caryophyllene, Citronellyl tiglate, Geranyl butyrate, β-Bourbonene.

Embodiments of the current disclosure describe a pest control composition comprising (i) mint oil (e.g., spearmint oil, cornmint oil, and mixtures thereof) and (ii) geranium oil.

In certain embodiments, the geranium oil and the mint oil have a weight ratio of from about 0.5:1 to about 20:1. In other embodiments, the geranium oil and the mint oil have a weight ratio of from about 0.6:1 to about 19:1. In some embodiments, the geranium oil and the mint oil have a weight ratio of from about 0.7:1 to about 19:1. In particular embodiments, the geranium oil and the mint oil have a weight ratio of from about 0.8:1 to about 18:1. In other embodiments, the geranium oil and the mint oil have a weight ratio of from about 0.9:1 to about 17:1. In certain embodiments the geranium oil and the mint oil have a weight ratio of from about 1:1 to about 16:1. While specific ratios chosen for this embodiment are recited, it is to be understood that, within the scope of the disclosure, the ratios of the geranium oil and the mint oil may vary to suit different applications.

In some embodiments, the pest control composition includes between about 0.001% to about 10% by weight of mint oil, based on the total weight of the composition. In other embodiments, the pest control composition includes between about 0.003% to about 9% by weight of mint oil, based on the total weight of the composition. In even further embodiments, the pest control composition includes between about 0.005% to about 8% by weight of mint oil, based on the total weight of the composition. In other embodiments, the pest control composition includes between about 0.008% to about 7% by weight of mint oil, based on the total weight of the composition. In particular embodiments, the pest control composition includes between about 0.01% to about 5% by weight of mint oil, based on the total weight of the composition. In some embodiments, the pest control composition includes between about 0.03% to about 4% by weight of mint oil, based on the total weight of the composition. In other embodiments, the pest control composition includes between about 0.05% to about 3% by weight of mint oil, based on the total weight of the composition. In particular embodiments, the pest control composition includes between about 0.1% to about 2.5% by weight of mint oil, based on the total weight of the composition. In accordance with exemplary embodiments, the mint oil is present in an amount of about 0.1%, 0.28%, 1.0%, or 2.5% by weight of the total composition. While specific values chosen for this embodiment are recited, it is to be understood that, within the scope of the disclosure, the concentrations of the mint oil may vary to suit different applications. The concentration ranges of mint oil will vary based on the additional components of the pest control composition, such as the geranium oil.

In certain embodiments, the pest control composition includes between about 0.01% to about 10% by weight of geranium oil, based on the total weight of the composition. In other embodiments, the pest control composition includes between about 0.03% to about 9% by weight of geranium oil, based on the total weight of the composition. In further embodiments, the pest control composition includes between about 0.05% to about 8.5% by weight of geranium oil, based on the total weight of the composition. In another embodiment, the pest control composition includes between about 0.1% to about 8% by weight of geranium oil, based on the total weight of the composition. In yet another embodiment, the pest control composition includes between about 0.3% to about 7% by weight of geranium oil, based on the total weight of the composition. In particular embodiments, the pest control composition includes between about 0.5% to about 6% by weight of geranium oil, based on the total weight of the composition. In other embodiments, the pest control composition includes between about 0.6% to about 5.5% by weight of geranium oil, based on the total weight of the composition. In particular embodiments, the pest control composition includes between about 1% to about 5% by weight of geranium oil, based on the total weight of the composition. In other embodiments, the pest control composition includes between about 1% to about 4.5% by weight of geranium oil, based on the total weight of the composition. In accordance with exemplary embodiments, the geranium oil is present in an amount of about 2.50%, 4.48%, 1.0%, or 1.6% by weight of the total composition. While specific values chosen for this embodiment are recited, it is to be understood that, within the scope of the disclosure, the concentrations of the geranium oil may vary to suit different applications. The concentration ranges of geranium oil will vary based on the additional components of the pest control composition, such as the mint oil.

In certain embodiments, the mint oil is spearmint oil.

In other embodiments, the mint oil is cornmint oil.

In even further embodiments, the mint oil is a combination of spearmint oil and cornmint oil.

The present disclosure also relates to a method of killing insects comprising applying to a surface in need thereof a composition comprising (i) mint oil (e.g., spearmint oil, cornmint oil, and mixtures thereof), and (ii) geranium oil.

Cinnamon oil. As used herein, “cinnamon oil” refers to both extracted and synthetic oils of species from the genus Cinnamomum in the family Lauraceae, and derivatives thereof. Cinnamon oil has the CAS registry number 8015-91-6 and can have at least one of the following constituents: benzenepropanal, borneol, 3-phenyl-2-propenal, trans-cinnamaldehyde, (+)-cyclosativene, alpha-cubebene, (+)-sativene, 1-caryophyllene, gamma-muurolene, gamma-maaliene, alpha-muurolene, 1,2,4a,5,6,8a-hexahydro-4,7-dimethyl-1-(1-methylethyl)naphthalene, d-cadinene, 1,6-dimethyl-4-(1-methyletyhl)-(1,2,3,4,4a,7)hexahydronaphthalene, 1,1,6-trimethyl-1,2-dihydronaphthalene, t-muurolol, and/or alpha-copaene. In particular embodiments, cinnamon oil may include the following major constituents: Eugenol, Eugenyl acetate, Linalool, (E)-Cinnamyl acetate, Benzyl benzoate, β-Caryophyllene, (E)-Cinnamaldehyde, Safrole, Cinnamyl alcohol.

Cedarwood oil. As used herein, “cedarwood oil” refers to both extracted and synthetic oils produced from distilling wood of a number of different junipers and cypresses (of the family Cupressaceae), and derivatives thereof. Cedarwood oil includes the following CAS registry numbers 85085-29-6, 68990-83-0, or 8000-27-9, and may include at least one of the following constituents: α-pinene, α-thujene, Camphene, β-pinene, Sabinene, Myrcene, α-terpinene, Limonene, β-phellandrene, γ-terpinene, p-cymene, Terpinolene, Isolongifolene, β-cubebene, Linalool, α-longipinene, α-cedrene, α-barbatene, β-cedrene, Terpinen-4-ol, β-funebrene, cis-p-menth-2-en-1-ol, Thujopsene (widdrene), allo-aromadendrene, β-barbatene, trans-piperitol, Selina-4,11-diene, β-chamigrene, α-terpineol, Pseudowiddrene, Bicyclogermacrene, α-cuprenene, Thujopsadiene, δ-cadinene, ar-curcumene, β-cuprenene, Cuparene, Dehydro-β-ionone, 8,9-dehydroneolongifolene, α-cedrol, Widdrol, 3-thujopsanone, α-cadinol, α-cedrenal, α-bisabolol, and/or Thujopsenal, Mayurone. In particular embodiments, cedarwood oil may include the following major constituents: Iso-α-cedrene, Thujopsene, Cedrenol, Cuparene, Longifolene, α-Cedrene, β-Cedrene, Cedrol, Widdrol, α-Chamigrene, β-Chamigrene, α-Selinene, β-Himachalene.

Rosemary oil. As used herein, “rosemary oil” refers to both extracted and synthetic versions of oils from Rosmarinus officinalis, Limonium vulgare, Andromeda polifolia, and derivatives thereof. Further, rosemary oil includes a CAS registry number of 8000-25-7, and may include at least one of the following constituents: tricyclene, alpha-thujene, alpha-pinene, camphene, sabinene, beta-pinene, myrcene, alpha-phellandrene, car-3-ene, alpha-terpinolene, p-cymene, 1,8-cineole, limonene, gamma-terpinene, trans-sabinene, terpinolene, linalool, alpha-campholenol, endo-fenchol, and/or camphor. In particular embodiments, rosemary oil may include the following major constituents: 1,8-cineole, borneol, camphor, verbenone, α-pinene, bornyl acetate, linalool, camphene, β-caryophyllene, α-terpineol, p-cymene, ar-curcumene, 1-nonanol, and terpinen-4-ol.

The pest control composition according to another embodiment of the present disclosure is a composition comprising (i) mint oil (e.g., spearmint oil, cornmint oil, and mixtures thereof), (ii) at least one of rosemary oil, geranium oil, cinnamon oil, cedarwood oil, and mixtures thereof, and (iii) at least one of ethyl lactate, butyl lactate, and mixtures thereof.

The pest control composition according to another embodiment of the present disclosure is a composition comprising (i) geranium oil and (ii) a second oil selected from the group consisting of spearmint oil, cornmint oil, cinnamon oil, and mixtures thereof. In other embodiments, the geranium oil and the second oil have a weight ratio of from about 0.5:1 to about 20:1. In some embodiments, the geranium oil and the second oil have a weight ratio of from about 0.6:1 to about 19:1. In certain embodiments, the geranium oil and the second oil have a weight ratio of from about 0.7:1 to about 19:1. In other embodiments, the geranium oil and the second oil have a weight ratio of from about 0.8:1 to about 18:1. In particular embodiments, the geranium oil and the second oil have a weight ratio of from about 0.9:1 to about 17:1. In certain embodiments the geranium oil and the second oil have a weight ratio of from about 1:1 to about 16:1. While specific ratios chosen for this embodiment are recited, it is to be understood that, within the scope of the disclosure, the ratios of the geranium oil and the second oil may vary to suit different applications.

In an embodiment, the second oil is spearmint oil.

In an embodiment, the second oil is cornmint oil.

In an embodiment, the second oil is cinnamon oil.

In certain embodiments of the current disclosure the pest control composition includes (i) mint oil (e.g., spearmint oil, cornmint oil, and mixtures thereof), (ii) geranium oil, and (iii) a third oil (e.g., cinnamon oil, cedarwood oil, and mixtures thereof).

In an embodiment, the pest control composition according to an embodiment of the present disclosure is a composition comprising (i) mint oil (e.g., spearmint oil, peppermint oil, cornmint oil, and mixtures thereof), (ii) geranium oil, and (iii) cinnamon oil. In other embodiments, the pest control composition includes essential oils consisting of (i) mint oil (e.g., spearmint oil, peppermint oil, cornmint oil, and mixtures thereof), (ii) geranium oil, and (iii) cinnamon oil. In some embodiments, the pest control composition includes essential oils consisting of (i) spearmint oil, (ii) geranium oil, and (iii) cinnamon oil. In particular embodiments, the pest control composition includes essential oils consisting of (i) peppermint oil, (ii) geranium oil, and (iii) cinnamon oil. In certain embodiments, the pest control composition includes essential oils consisting of (i) cornmint oil, (ii) geranium oil, and (iii) cinnamon oil.

In other embodiments, the pest control composition includes between about 0.01% to about 10% by weight of the third oil, based on the total weight of the composition. In some embodiments, the pest control composition includes between about 0.03% to about 9% by weight of the third oil, based on the total weight of the composition. In certain embodiments, the pest control composition includes between about 0.05% to about 8% by weight of the third oil, based on the total weight of the composition. In particular embodiments, the pest control composition includes between about 0.1% to about 7% by weight of the third oil, based on the total weight of the composition. In other embodiments, the pest control composition includes between about 0.3% to about 6% by weight of the third oil, based on the total weight of the composition. In some embodiments, the pest control composition includes between about 0.5% to about 5% by weight of the third oil, based on the total weight of the composition. In certain embodiments, the pest control composition includes between about 1% to about 3% by weight of the third oil, based on the total weight of the composition. In other embodiments, the pest control composition includes between about 1% to about 2.8% by weight of the third oil, based on the total weight of the composition. In accordance with exemplary embodiments, the third oil is present in an amount of about 2.8%, 1.0%, or 2.5% by weight of the total composition. While specific values chosen for this embodiment are recited, it is to be understood that, within the scope of the disclosure, the concentrations of the third oil may vary to suit different applications. The concentration ranges of the third oil will vary based on the additional components of the pest control composition, such as the mint oil and the geranium oil.

In certain embodiments, the third oil is cinnamon oil.

In certain embodiments, the third oil is cedarwood oil.

In certain embodiments, the third oil is a mixture of cinnamon oil and cedarwood oil.

The pest control composition according to another embodiment of the present disclosure is a composition comprising (i) mint oil (e.g., spearmint oil, peppermint oil, cornmint oil, and mixtures thereof), (ii) at least one of rosemary oil, geranium oil, cinnamon oil, cedarwood oil, and mixtures thereof, (iii) at least one of ethyl lactate, butyl lactate, isopropyl alcohol, and mixtures thereof, and (iv) isopropyl myristate.

The present disclosure also relates to a method of killing insects comprising applying to a surface in need thereof a composition comprising (i) mint oil (e.g., spearmint oil, peppermint oil, cornmint oil, and mixtures thereof), and (ii) geranium oil.

Embodiments of the present disclosure also include a method of killing insects comprising applying to a surface in need thereof a composition comprising at least one of spearmint oil, peppermint oil, cornmint oil, and mixtures thereof, at least one oil comprising rosemary oil, geranium oil, cinnamon oil, cedarwood oil, and mixtures thereof, and at least one of ethyl lactate, butyl lactate, and mixtures thereof.

Embodiments of the present disclosure also include a method of killing insects comprising applying to a surface in need thereof a composition comprising at least one of spearmint oil, peppermint oil, cornmint oil, and mixtures thereof, at least one oil comprising rosemary oil, geranium oil, cinnamon oil, cedarwood oil, and mixtures thereof, at least one of ethyl lactate, butyl lactate, isopropyl alcohol, and mixtures thereof, and isopropyl myristate.

Eugenol. As used herein, “eugenol” refers to both extracted and synthetic versions of 4-allyl-2-methoxyphenol from Eugenia caryophyllata, and derivatives thereof. Further, eugenol includes a CAS registry number of 97-53-0.

The pest control composition according to another embodiment of the present disclosure is a composition comprising (i) eugenol, (ii) from about 50% to about 80% by weight water, and (iii) a solvent (e.g., ethyl lactate, butyl lactate, isopropyl alcohol, isopropyl myristate, and combinations thereof). In other embodiments, the composition includes at least 3% by weight eugenol, based on the total weight of the composition. In some embodiments, the composition includes about 12% by weight eugenol, based on the total weight of the composition. In particular embodiments, the composition includes greater than about 15% by weight of the solvent, based on the total weight of the composition. In an embodiment, the composition comprises greater than about 6% by weight of the solvent, based on the total weight of the composition. In certain embodiments, the composition includes about 6.5% by weight of the solvent, based on the total weight of the composition.

The pest control composition according to another embodiment of the present disclosure is a composition comprising (i) eugenol, (ii) water, and (iii) greater than about 15% by weight of a solvent (e.g., ethyl lactate, butyl lactate, isopropyl alcohol, isopropyl myristate, and combinations thereof). In other embodiments, the composition includes at least 3% by weight eugenol, based on the total weight of the composition. In an embodiment, the composition comprises at least 12% by weight eugenol, based on the total weight of the composition. In an embodiment, the composition comprises about 50% to about 80% by weight water, based on the total weight of the composition. In an embodiment, the composition comprises about 65% to about 78% by weight water, based on the total weight of the composition. In some embodiments, the composition includes about 50% to about 75% by weight water, based on the total weight of the composition.

In certain embodiments, the pest control composition includes eugenol. In other embodiments, the pest control composition includes at least about 3% by weight of eugenol, based on the total weight of the composition. In particular embodiments, the composition includes at least about 4% by weight of eugenol, based on the total weight of the composition. In certain embodiments, the composition includes at least about 5% by weight of eugenol, based on the total weight of the composition. In other embodiments, the composition includes at least about 6% by weight of eugenol, based on the total weight of the composition. In some embodiments, the composition includes at least about 7% by weight of eugenol, based on the total weight of the composition. In certain embodiments, the composition includes at most about 12% by weight of eugenol, based on the total weight of the composition. In certain embodiments, the composition includes at most about 11% by weight of eugenol, based on the total weight of the composition. In other embodiments, the composition includes at most about 10% by weight of eugenol, based on the total weight of the composition. In particular embodiments, the composition includes at most about 9% by weight of eugenol, based on the total weight of the composition. In exemplary embodiments, the composition includes about 8% or about 12% of eugenol, based on the total weight of the composition. While specific values chosen for this embodiment are recited, it is to be understood that, within the scope of the disclosure, the concentration of the eugenol may vary to suit different applications. The concentration ranges of the solvent will vary based on the additional components of the pest control composition, such as the water and the solvent.

The pest control composition according to another embodiment of the present disclosure is a composition comprising (i) at least about 3% by weight of eugenol, (ii) water, and (iii) a solvent (e.g., ethyl lactate, butyl lactate, isopropyl alcohol, isopropyl myristate, and combinations thereof). In certain embodiments, the composition includes about 50% to about 85% by weight water, based on the total weight of the composition. In other embodiments, the composition includes about 55% to about 80% by weight water, based on the total weight of the composition. In some embodiments, the composition the composition includes about 60% to about 80% by weight water, based on the total weight of the composition. In certain embodiments, the composition the composition includes about 65% to about 80% by weight water, based on the total weight of the composition. In other embodiments, the composition the composition includes about 68% to about 78% by weight water, based on the total weight of the composition. In particular embodiments, the composition the composition includes about 68.3% to about 73.8% by weight water, based on the total weight of the composition. In an exemplary embodiment, the composition includes about 68.25%, 69.1, 71.10%, 70.98%, 73.83%, 70.25%, 73.10%, or 77.1% of water, based on the total weight of the composition. While specific values chosen for this embodiment are recited, it is to be understood that, within the scope of the disclosure, the concentration of water may vary to suit different applications. The concentration ranges of water will vary based on the additional components of the pest control composition, such as the eugenol and the solvent.

In certain embodiments, the pest control composition includes greater than about 15% by weight of the solvent, based on the total weight of the composition. In other embodiments, the composition includes greater than about 15.5% by weight of the solvent, based on the total weight of the composition. In some embodiments, the composition includes greater than about 16% by weight of the solvent, based on the total weight of the composition. In certain embodiments, the composition includes greater than about 16.5% by weight of the solvent, based on the total weight of the composition. In exemplary embodiments, the composition includes about 16.9% or 6.5% of solvent, based on the total weight of the composition. While specific values chosen for this embodiment are recited, it is to be understood that, within the scope of the disclosure, the concentration of the solvent may vary to suit different applications. The concentration ranges of the solvent will vary based on the additional components of the pest control composition, such as the eugenol and water.

The pest control composition according to another embodiment of the present disclosure is a composition comprising (i) eugenol and (ii) a first solvent consisting of butyl lactate. In other embodiments, the composition includes about 3% by weight to about 15% by weight of eugenol, based on the total weight of the composition. In certain embodiments, the pest control composition includes about 4% by weight to about 14% by weight of eugenol, based on the total weight of the composition. In certain embodiments, the composition includes about 7% by weight to about 12% by weight of eugenol, based on the total weight of the composition. In some embodiments, the composition includes about 7.5% by weight to about 10% by weight of eugenol, based on the total weight of the composition. In other embodiments, the composition includes about 7.5% by weight to about 9% by weight of eugenol, based on the total weight of the composition. In an exemplary embodiment, the composition includes about 4% or about 8% or about 12% of eugenol, based on the total weight of the composition. While specific values chosen for this embodiment are recited, it is to be understood that, within the scope of the disclosure, the concentration of the eugenol may vary to suit different applications. The concentration ranges of the eugenol will vary based on the additional components of the pest control composition, such as the first solvent.

In certain embodiments, the composition includes about 5% by weight to about 10% by weight of the first solvent, based on the total weight of the composition. In certain embodiments, the composition includes about 5.5% by weight to about 8% by weight of the first solvent, based on the total weight of the composition. In some embodiments, the composition includes about 6% by weight to about 7% by weight of the first solvent, based on the total weight of the composition. In other embodiments, the composition includes about 6.4% by weight to about 6.6% by weight of the first solvent, based on the total weight of the composition. In an exemplary embodiment, the composition includes about 6.5% of the first solvent, based on the total weight of the composition. While specific values chosen for this embodiment are recited, it is to be understood that, within the scope of the disclosure, the concentration of the first solvent may vary to suit different applications. The concentration ranges of the first solvent will vary based on the additional components of the pest control composition, such as eugenol.

In certain embodiments, the composition includes a second solvent (e.g., ethyl lactate, isopropyl alcohol, isopropyl myristate, and combinations thereof). In some embodiments, the composition includes about 5% by weight to about 15% by weight of the second solvent, based on the total weight of the composition. In certain embodiments, the composition includes about 6% by weight to about 14% by weight of the second solvent, based on the total weight of the composition. In other embodiments, the composition includes about 7% by weight to about 13% by weight of the second solvent, based on the total weight of the composition. In some embodiments, the composition includes about 8% by weight to about 12% by weight of the second solvent, based on the total weight of the composition. In particular embodiments, the composition includes about 9% by weight to about 11% by weight of the second solvent, based on the total weight of the composition. In an exemplary embodiment, the composition includes about 10.4% of the second solvent, based on the total weight of the composition. While specific values chosen for this embodiment are recited, it is to be understood that, within the scope of the disclosure, the concentration of the second solvent may vary to suit different applications. The concentration ranges of the first solvent will vary based on the additional components of the pest control composition, such as eugenol and the first solvent.

In an embodiment, the solvent is ethyl lactate. In certain embodiments, the composition is substantially free of ethyl lactate. In other embodiments, the composition includes about 3% to about 15% by weight ethyl lactate, based on the total weight of the composition. In some embodiments, the composition includes about 6% to about 7% by weight ethyl lactate, based on the total weight of the composition. In certain embodiments, the composition includes about 6.4% to about 6.6% by weight ethyl lactate, based on the total weight of the composition. While specific values chosen for this embodiment are recited, it is to be understood that, within the scope of the disclosure, the concentration of ethyl lactate may vary to suit different applications. The concentration ranges of ethyl lactate will vary based on the additional components of the pest control composition, such as the eugenol and the first solvent.

In an embodiment, the solvent is isopropyl alcohol. In some embodiments, the composition is substantially free of isopropyl alcohol. In other embodiments, the composition includes about 3% to about 15% by weight isopropyl alcohol. In certain embodiments, the composition includes about 5% to about 10% by weight isopropyl alcohol. In particular embodiments, the composition includes comprising about 6% to about 7% by weight isopropyl alcohol. In other embodiments, the composition includes comprising about 6.4% to about 6.6% by weight isopropyl alcohol. While specific values chosen for this embodiment are recited, it is to be understood that, within the scope of the disclosure, the concentration of isopropyl alcohol may vary to suit different applications. The concentration ranges of isopropyl alcohol will vary based on the additional components of the pest control composition, such as the eugenol and the first solvent.

In an embodiment, the solvent is isopropyl myristate. In some embodiments, the composition is substantially free of isopropyl myristate. In certain embodiments, the composition includes about 1% to about 15% by weight isopropyl myristate, based on the total weight of the composition. In certain embodiments, the composition includes about 5% to about 13% by weight isopropyl myristate, based on the total weight of the composition. In other embodiments, the composition includes about 8% to about 12% by weight isopropyl myristate, based on the total weight of the composition. In some embodiments, the composition includes about 10% to about 11% by weight isopropyl myristate, based on the total weight of the composition. While specific values chosen for this embodiment are recited, it is to be understood that, within the scope of the disclosure, the concentration of isopropyl myristate may vary to suit different applications. The concentration ranges of isopropyl myristate will vary based on the additional components of the pest control composition, such as the eugenol and the first solvent.

In certain embodiments, the composition includes water. In certain embodiments, the composition includes about 50% by weight to about 80% by weight of water, based on the total weight of the composition. In other embodiments, the composition includes about 55% by weight to about 78% by weight of water, based on the total weight of the composition. In some embodiments, the composition includes about 60% by weight to about 78% by weight of water, based on the total weight of the composition. In particular embodiments, the composition includes about 68% by weight to about 78% by weight of water, based on the total weight of the composition. In some embodiments, the composition includes about 69% by weight to about 78% by weight of water, based on the total weight of the composition. In an exemplary embodiment, the composition includes about 69.10%, 70.98%, 73.83%, 70.25%, 73.10%, or 71.1% of water, based on the total weight of the composition. While specific values chosen for this embodiment are recited, it is to be understood that, within the scope of the disclosure, the concentration of water may vary to suit different applications. The concentration ranges of water will vary based on the additional components of the pest control composition, such as eugenol and the first solvent.

In other embodiments, the composition includes a propellant. In certain embodiments, the propellant includes at least one of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In some embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In certain embodiments, the composition includes about 1% to about 5% by weight of the propellant, based on the total weight of the composition. In other embodiments, the composition includes about 1.5% to about 4.5% by weight of the propellant, based on the total weight of the composition. In particular embodiments, the composition includes about 2% to about 4% by weight of the propellant, based on the total weight of the composition. In some embodiments, the composition includes about 2.5% to about 3.5% by weight of the propellant, based on the total weight of the composition. In other embodiments, the composition includes about 2.7% to about 3% by weight of the propellant, based on the total weight of the composition. While specific values chosen for this embodiment are recited, it is to be understood that, within the scope of the disclosure, the concentration of propellant may vary to suit different applications. The concentration ranges of propellant will vary based on the additional components of the pest control composition, such as the eugenol and the first solvent.

In certain embodiments, the composition includes about 1% to about 5% by weight of the surfactant, based on the total weight of the composition. In other embodiments, the composition includes about 1.3% to about 4.5% by weight of the surfactant, based on the total weight of the composition. In certain embodiments, the composition includes about 1.5% to about 3.5% by weight of the surfactant, based on the total weight of the composition. In some embodiments, the composition includes about 1.8% to about 3% by weight of the surfactant, based on the total weight of the composition. In particular embodiments, the composition includes about 1% to about 2% by weight of the surfactant, based on the total weight of the composition. While specific values chosen for this embodiment are recited, it is to be understood that, within the scope of the disclosure, the concentration of surfactant may vary to suit different applications. The concentration ranges of surfactant will vary based on the additional components of the pest control composition, such as the eugenol and the first solvent.

The present disclosure also relates to a pest control composition and a method of killing insects comprising applying to a surface in need thereof a composition comprising eugenol, water, and a solvent (e.g., ethyl lactate, butyl lactate, isopropyl alcohol, isopropyl myristate, and combinations thereof).

Embodiments of the present disclosure also include a method of killing insects comprising applying to a surface in need thereof a composition comprising at least about 3% by weight of eugenol, water, and a solvent (e.g., ethyl lactate, butyl lactate, isopropyl alcohol, isopropyl myristate, and combinations thereof).

Embodiments of the present disclosure also include a method of killing insects comprising applying to a surface in need thereof a composition comprising eugenol, from about 50% to about 80% by weight water, and a solvent (e.g., ethyl lactate, butyl lactate, isopropyl alcohol, isopropyl myristate, and combinations thereof).

Embodiments of the present disclosure also include a method of killing insects comprising applying to a surface in need thereof a composition comprising eugenol, water, and greater than about 15% by weight of a solvent (e.g., ethyl lactate, butyl lactate, isopropyl alcohol, isopropyl myristate, and combinations thereof).

In further embodiments, other plant-based insecticidal natural oil or natural oil extract that may be contained in the embodiments of compositions for killing and/or repelling insects described herein may comprise neem oil, karanja oil, clove oil, thyme oil, oregano oil, garlic oil, anise oil, lime oil, lavender oil, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others), or mixtures thereof. In other embodiments, the insecticidal natural oil may comprise any oil having as a constituent one of the following compounds, or a combination of the following compounds: azadirachtin, nimbin, nimbinin, salannin, gedunin, geraniol, geranial, gamma-terpinene, alpha-terpin-eol, beta-caryophyllene, terpinen-4-ol, myrcenol-8, thuya-nol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cin-eole, eugenol, limonene, alpha-pinene, menthol, menthone, linalool, or mixtures thereof.

In further embodiments, other plant-based essential oil or extracts or fractions thereof that may be contained in the embodiments of compositions for killing insects described herein may comprise alpha- or beta-pinene; alpha-camp-holenic aldehyde; alpha-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., Dianthus caryophyllus); carvacrol; carveol; cassia; castor; cedar (e.g., hinoki); chamomile; cineole; cinnamaldehyde; cinnamic alcohol; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; Citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihy drolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Femiol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methylacetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; Litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methylcyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., Myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini), patchouli (e.g., Pogostemon cablin), p-cymene; pennyroyal oil; pepper; peppermint (e.g., Mentha piperita), perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis), ryu; sage; sandalwood (e.g., Santalum album), sandenol; sassafras; sesame; soybean; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, or mixtures thereof.

Other suitable essential oils for use in the pest control compositions described herein include Absinth Oil, Almond Oil, Ambrette Seed Oil, Amyris Oil, Angelica Root Oil, Anethole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedar leaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea cubeba Berry Oil, Mace Oil, Mandarin Oil Cold Pressed, Marjoram Oil Sweet, Musk Oil, Myrtel Oil, Neroli Oil, Nutmeg Oil, Ocotea cymbarum Oil, Onion Oil, Orange Oil Bitter Cold Pressed, Orange Oil 10-Fold, Orange Oil 20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil, Petitgrain Oil, Pimenta Berry Oil, Pimenta Leaf Oil, Pine Needle Oil, Pine Oil Scotch, Pine Oil White, Rosalin Oil, Rose Oil, Sage Clary Oil, Sage Oil, Sandalwood Oil, Sassafras Oil, Savory Oil, Spike Lavender Oil (Lavender Spike), Spruce Oil (Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Turpentine Oil, Valerian Oil, Vanilla beans abs., Vetiver Oil, Wintergreen Oil (Methyl Salicylate Natural), Wormseed Oil, Wormwood Oil, and Ylang Ylang Oil.

In certain circumstances, the composition may include one or more ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25(f), for example, included, but not limited to, those listed as “Active Ingredients Permitted in Exempted Minimum Risk Pesticide Products” in 40 U.S. Code of Federal Regulations 152.25(f).

The compositions of the present disclosure may also include one or more additional components. In other embodiments, for example, the compositions of the present disclosure may include a carrier, a solvent, a preservative, a surfactant, and/or a propellant.

Carrier. In certain embodiments, the pest control composition includes a carrier. The term “carrier” as used herein means a material, which can be inorganic or organic and of synthetic or natural origin, with which the active component is mixed or formulated to facilitate its application to the host, area, or other object to be treated, or to facilitate its storage, transport and/or handling. In general, any of the materials customarily employed in formulating repellents, pesticides, herbicides, or fungicides, are suitable.

The pest control composition according to an embodiment of the present disclosure is a composition comprising (i) mint oil selected from the group consisting of spearmint oil, cornmint oil, and mixtures thereof, (ii) geranium oil, and (iii) a carrier. In some embodiments, the carrier includes water. In other embodiments, the carrier is water.

In certain embodiments, the carrier includes about 55% to about 85% by weight carrier, based on the total weight of the composition. In certain embodiments, the carrier includes about 57% to about 83% by weight carrier, based on the total weight of the composition. In other embodiments, the carrier includes about 59% to about 80% by weight carrier, based on the total weight of the composition. In some embodiments, the carrier includes about 61% to about 79% by weight carrier, based on the total weight of the composition. In particular embodiments, the carrier includes about 65% to about 78% by weight carrier, based on the total weight of the composition. While specific values chosen for this embodiment are recited, it is to be understood that, within the scope of the disclosure, the amount of carrier may vary to suit different applications. The amount ranges of carrier will vary based on the additional components of the pest control composition, such as the mint oil and the geranium oil.

In an embodiment, the carrier includes water. In certain embodiments, the carrier is water.

Solvent. The formulation or composition may include a solvent, for example to dissolve other components, to enhance functionality of the components, or for textural and sensorial attributes. In particular embodiments, the pest control composition includes a solvent. In some embodiments, the solvent includes ethyl lactate, butyl lactate, isopropyl alcohol, isopropyl myristate, and/or combinations thereof.

In an embodiment, the solvent includes at least one of ethyl lactate, butyl lactate, isopropyl alcohol, isopropyl myristate, and combinations thereof. Additionally, according to one embodiment, the solvent includes at least one of ethyl lactate, butyl lactate, isopropyl myristate, and combinations thereof. In yet another embodiment, the solvent includes at least one of ethyl lactate, butyl lactate, and combinations thereof. In still another embodiment, the solvent is selected from the group consisting of ethyl lactate, butyl lactate, isopropyl alcohol, isopropyl myristate, and combinations thereof. In a particular embodiment, the solvent includes at least one of ethyl lactate, butyl lactate, and combinations thereof.

In some embodiments, the pest control composition includes a solvent. In an embodiment, the solvent is present in an amount from about 1% to about 50% by weight, based on the total weight of the composition. In other embodiments, the pest control composition includes about 15% to about 30% by weight of the solvent, based on the total weight of the composition. In particular embodiments, the pest control composition includes about 15.5% to about 28% by weight of the solvent, based on the total weight of the composition. In other embodiments, the pest control composition includes about 16% to about 27% by weight of the solvent, based on the total weight of the composition. In particular embodiments, the pest control composition includes about 16.5% to about 26% by weight of the solvent, based on the total weight of the composition. In other embodiments, the pest control composition includes about 17% to about 25% by weight of the solvent, based on the total weight of the composition. In certain embodiments, the pest control composition includes about 17.4% to about 24.1% by weight of the solvent, based on the total weight of the composition. In other embodiments, the pest control composition includes about 6% to about 7% by weight of the solvent, based on the total weight of the composition. In accordance with exemplary embodiments, the solvent is present in an amount of about 17.43% or 21.43% by weight of the total composition, or about 6.5% by weight of the total composition. While specific values chosen for this embodiment are recited, it is to be understood that, within the scope of the disclosure, the concentrations of the solvent may vary to suit different applications. The concentration ranges of the solvent will vary based on the additional components of the pest control composition, such as the mint oil and the geranium oil.

In some embodiments, the pest control composition includes greater than about 15% by weight of the solvent, based on the total weight of the composition. In certain embodiments, the composition includes greater than about 15.5% by weight of the solvent, based on the total weight of the composition. In particular embodiments, the composition includes greater than about 16% by weight of the solvent, based on the total weight of the composition. In other embodiments, the composition includes greater than about 16.5% by weight of the solvent, based on the total weight of the composition. In exemplary embodiments, the composition includes about 16.9% or 6.5% of solvent, based on the total weight of the composition. While specific values chosen for this embodiment are recited, it is to be understood that, within the scope of the disclosure, the concentration of the solvent may vary to suit different applications. The concentration ranges of the solvent will vary based on the additional components of the pest control composition, such as the eugenol and water.

In an embodiment, the solvent is ethyl lactate. In some embodiments, the composition is substantially free of ethyl lactate. In certain embodiments, the composition includes about 3% to about 15% by weight ethyl lactate, based on the total weight of the composition. In other embodiments, the composition includes about 6% to about 7% by weight ethyl lactate, based on the total weight of the composition. In particular embodiments, the composition includes about 6.4% to about 6.8% by weight ethyl lactate, based on the total weight of the composition. In some embodiments, the composition includes about 6.4% to about 6.6% by weight ethyl lactate, based on the total weight of the composition. While specific values chosen for this embodiment are recited, it is to be understood that, within the scope of the disclosure, the concentration of ethyl lactate may vary to suit different applications. The concentration ranges of ethyl lactate will vary based on the additional components of the pest control composition, such as the mint oil, the geranium oil, and the carrier, or such as the eugenol and the water.

In an embodiment, the solvent is butyl lactate. In other embodiments, the composition is substantially free of butyl lactate. In certain embodiments, the composition includes about 3% to about 15% by weight butyl lactate, based on the total weight of the composition. In certain embodiments, the composition includes about 6% to about 7% by weight butyl lactate, based on the total weight of the composition. In other embodiments, the composition includes about 6.4% to about 6.8% by weight butyl lactate, based on the total weight of the composition. In some embodiments, the composition includes about 6.4% to about 6.6% by weight butyl lactate, based on the total weight of the composition. While specific values chosen for this embodiment are recited, it is to be understood that, within the scope of the disclosure, the concentration of butyl lactate may vary to suit different applications. The concentration ranges of butyl lactate will vary based on the additional components of the pest control composition, such as the mint oil, the geranium oil, and the carrier, or such as the eugenol and the water.

In an embodiment, the solvent is isopropyl alcohol. In certain embodiments, the composition is substantially free of isopropyl alcohol. In other embodiments, the composition includes about 3% to about 15% by weight isopropyl alcohol. In further embodiments, the composition includes about 5% to about 10% by weight isopropyl alcohol. In other embodiments, the composition includes about 6% to about 7% by weight isopropyl alcohol. In particular embodiments, the composition includes comprising about 6.4% to about 6.6% by weight isopropyl alcohol. In particular embodiments, the composition includes about 6.6% to about 6.8% by weight isopropyl alcohol. While specific values chosen for this embodiment are recited, it is to be understood that, within the scope of the disclosure, the concentration of isopropyl alcohol may vary to suit different applications. The concentration ranges of isopropyl alcohol will vary based on the additional components of the pest control composition, such as the mint oil, the geranium oil, and the carrier, or such as the eugenol and the water.

In an embodiment, the solvent is isopropyl myristate. In some embodiments, the composition is substantially free of isopropyl myristate. In other embodiments, the composition includes about 1% to about 15% by weight isopropyl myristate, based on the total weight of the composition. In other embodiments, the composition includes about 5% to about 13% by weight isopropyl myristate, based on the total weight of the composition. In further embodiments, the composition includes about 8% to about 12% by weight isopropyl myristate, based on the total weight of the composition. In particular embodiments, the composition includes about 10% to about 11% by weight isopropyl myristate, based on the total weight of the composition. While specific values chosen for this embodiment are recited, it is to be understood that, within the scope of the disclosure, the concentration of isopropyl myristate may vary to suit different applications. The concentration ranges of isopropyl myristate will vary based on the additional components of the pest control composition, such as the mint oil, the geranium oil, and the carrier, or such as the eugenol and the water.

In certain embodiments, substantially absent from the pest control composition is a hydrocarbon solvent selected from the group consisting of aliphatic C₉-C₁₇ hydrocarbons, alicyclic C₉-C₁₇ hydrocarbons, naphtha, petroleum distillate, paraffins, iso-paraffins, isoparaffinic hydrocarbons, cycloparaffins, alkanes, iso-alkanes, cycloalkanes, and any combinations thereof. In some embodiments, absent from the pest control composition is a hydrocarbon solvent selected from the group consisting of aliphatic C₉-C₁₇ hydrocarbons, alicyclic C₉-C₁₇ hydrocarbons, naphtha, petroleum distillate, paraffins, iso-paraffins, isoparaffinic hydrocarbons, cycloparaffins, alkanes, iso-alkanes, cycloalkanes, and any combinations thereof.

Surfactant. The formulation may include a surfactant, for example to lower the surface tension of the composition. In some embodiments, the composition includes a surfactant. In some embodiments, the surfactant includes at least one of lecithin, sodium lauryl sulfate, sodium oleate, potassium oleate, sodium ricinolate, Quillaja saponin, polyglyceryl oleate, glyceryl monooleate, and any combinations thereof. In other embodiments, the surfactant is selected from the group consisting of lecithin, sodium lauryl sulfate, sodium oleate, potassium oleate, sodium ricinolate, Quillaja saponin, polyglyceryl oleate, glyceryl monooleate, and any combinations thereof.

In certain embodiments, the surfactant is present in about 1% to about 5%, based on the total weight of the composition. In an embodiment, the surfactant is present from about 1% to about 4.5% by weight, based on the total weight of the composition. In other embodiments, the composition includes about 1.3% to about 4.3% by weight of the surfactant, based on the total weight of the composition. In some embodiments, the composition includes about 1.5% to about 4% by weight of the surfactant, based on the total weight of the composition. In certain embodiments, the composition includes about 2% to about 3.7% by weight of the surfactant, based on the total weight of the composition. In an embodiment, the surfactant is present from about 1% to about 2% by weight, based on the total weight of the composition. In even further embodiments, however, the composition is substantially free of a surfactant. While specific values chosen for this embodiment are recited, it is to be understood that, within the scope of the disclosure, the concentration of surfactant may vary to suit different applications. The concentration ranges of surfactant will vary based on the additional components of the pest control composition, such as the mint oil, the geranium oil, and the carrier, or such as the eugenol, the water, and the solvent.

In other embodiments, the composition includes about 1% to about 5% by weight of the surfactant, based on the total weight of the composition. In certain embodiments, the composition includes about 1.3% to about 4.5% by weight of the surfactant, based on the total weight of the composition. In other embodiments, the composition includes about 1.5% to about 3.5% by weight of the surfactant, based on the total weight of the composition. In some embodiments, the composition includes about 1.8% to about 3% by weight of the surfactant, based on the total weight of the composition. In particular embodiments, the composition includes about 1% to about 2% by weight of the surfactant, based on the total weight of the composition. While specific values chosen for this embodiment are recited, it is to be understood that, within the scope of the disclosure, the concentration of surfactant may vary to suit different applications. The concentration ranges of surfactant will vary based on the additional components of the pest control composition, such as the eugenol and the first solvent.

Preservative. According to even further embodiments of the present disclosure, the composition may also include a preservative, for example, to lengthen the shelf-life of the product composition. In an embodiment, the composition includes a preservative. In other embodiments, the composition is substantially free of a preservative. In certain embodiments, the preservative includes sodium benzoate. In some embodiments, the preservative is sodium benzoate.

In some embodiments, the composition includes about 0.1% to about 0.5% by weight preservative. In even further embodiments, the composition includes about 0.15% to about 0.45% by weight preservative. In particular embodiments, the composition includes about 0.2% to about 0.4% by weight preservative. While specific values chosen for this embodiment are recited, it is to be understood that, within the scope of the disclosure, the concentration of preservative may vary to suit different applications. The concentration ranges of preservative will vary based on the additional components of the pest control composition, such as the mint oil and the geranium oil, or such as the eugenol, the water, and the solvent.

Propellant. According to embodiments of the present disclosure, the composition and formulations may include a propellant, for example to provide a force to expel the formulation from the container. Here, the insecticidally-active compositions of the present disclosure may be combined with a suitable propellant to form an aerosol formulation. In certain embodiments, the composition also includes a propellant. However, in other embodiments, the composition does not include a propellant and may be dispensed from a container manually, such as from a trigger-actuated container. In some embodiments, the pest control composition includes a propellant. In other embodiments, the propellant includes of at least one of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In particular embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. Examples of suitable propellants include compressed gas propellants such as nitrogen, carbon dioxide, and nitrous oxide; liquefied gas propellants such as fluorinated and chlorinated hydrocarbons, dimethyl ether, vinyl chloride; saturated hydrocarbons or lower (C₁-C₄) aliphatic hydrocarbons, such as propane, butane, isobutane, isopentane, and mixtures thereof; and mixtures of liquefied gases and compressed gases. In order to reduce environmental pollution, it may be preferred to employ compressed gases as the propellant rather than, or in the place of, liquefied saturated hydrocarbons.

The pest control composition according to an embodiment of the present disclosure is a composition comprising i) mint oil selected from the group consisting of spearmint oil, cornmint oil, and mixtures thereof, (ii) geranium oil, (iii) a carrier, and (iv) a propellant.

In certain embodiments, the composition includes about 1% to about 5% by weight of the propellant, based on the total weight of the composition. In other embodiments, the composition includes about 1.5% to about 4.5% by weight of the propellant, based on the total weight of the composition. In further embodiments, the composition includes about 2% to about 4% by weight of the propellant, based on the total weight of the composition. In even further embodiments, the composition includes about 2.5% to about 3.5% by weight of the propellant, based on the total weight of the composition. In particular embodiments, the composition includes about 2.7% to about 3% by weight of the propellant, based on the total weight of the composition. While specific values chosen for this embodiment are recited, it is to be understood that, within the scope of the disclosure, the concentration of propellant may vary to suit different applications. The concentration ranges of propellant will vary based on the additional components of the pest control composition, such as the mint oil, the geranium oil, and the carrier, or such as the eugenol, the water, and the solvent, or such as such as the eugenol and the first solvent. In other embodiments, the hydrocarbon propellant may be present in the compositions of this disclosure in an amount of from about 8% to about 50%, from about 15% to about 50%, from about 15% to about 40%, from about 15% to about 25%, or from about 5% to about 30% by weight, based on the total weight of the composition.

Any of the embodiments described herein may be modified to include any of the structures, compositions, or methodologies disclosed in connection with different embodiments.

### EXAMPLES

The following Examples are provided to demonstrate and further illustrate certain embodiments and aspects of the present disclosure and are not to be construed as limiting the scope of the disclosure.

In certain embodiments, as will be illustrated through the Examples, the pest control composition provides a pest mortality rate of about 100% in 24 hours, and in some embodiments, the pest control composition provides a pest knockdown rate of about 90% in 30 seconds.

Unless stated otherwise, the efficacy tests were conducted in accordance with the U.S. Environmental Protection Agency Product Performance Test Guidelines, OCSPP 810.3500: Premises Treatments, which provides recommendations for the design and execution of laboratory and field studies to evaluate the performance of pesticide products applied in or around premises in connection with registration of pesticide products under the Federal Insecticide, Fungicide, and Rodenticide Act (FIFRA) (7 U.S.C. 136, et seq.). The entire contents of these testing guidelines are incorporated by reference herein.

In general, the following data was recorded for each sample set: sample group size, genus species, sex, maturity and general condition. The number of insects knocked down after thirty seconds and number of insects dead after twenty-four hours post treatment were also recorded. The conditions of the testing area (temperature, humidity, date and time) were also clearly associated with each testing round of samples and control. Additionally, the knockdown and mortality results were reported in both number relative to sample size and as a percentage of the sample size.

During the tests, the formulations were tested on a variety of insects. For flying insects, the formulations were tested by holding the insects (e.g., mosquitos, Culex quinquefasciatus, flies, Musca domestica) in a container with a screened bottom and top openings to prevent pooling of the sample and based on the targets' size and ability to escape. The insects were directly sprayed with the composition while in the container. Knockdown observations were taken thirty seconds after application of the formulation. Afterwards, the insects were to be transferred to a clean container, given water and held for twenty-four-hour mortality observation, after which time the total number of dead insects was recorded. A group of untreated insects were also held in clean containers for twenty-four hours mortality observation as a control to the treated test system.

For crawling insects, the formulations were tested by treating the insects (e.g., cockroaches, Blattella germanica, Periplaneta americana, ants, Linepithema humile, Monomorium pharaonis) on a large platform with clean craft paper placed on its surface. A large “arena” ring was placed on top of the paper, with a smaller treatment ring in the center, placed on top of a sheet of vinyl flooring. Twenty seconds after treatment the smaller treatment ring was removed. Knockdown observations were taken thirty seconds after application of formulation to the insects. Approximately two minutes post treatment, insects were collected from the arena and placed into clean holding containers for twenty-four-hour mortality observations. A group of untreated insects were also held in clean containers for twenty-four-hour mortality observations as a control to the treated test system.

Several formulations according to embodiments of the present disclosure were tested and efficacy data, including knockdown and mortality data, was collected for the formulations.

### Example 1

Formulations A, B, C, and D are water-based pest control formulations and comprise about 0.1% or about 1% spearmint or peppermint or cornmint oil; about 1% or about 1.6% geranium oil; about 1% cinnamon oil; about 1% cedarwood oil; about 74% to about 78% water; about 10.7% isopropyl myristate; about 6.7% ethyl lactate or butyl lactate or isopropyl alcohol; about 2% surfactant; and about 2.9% of an optional propellant.

The following ingredients in Table 1 are combined to prepare formulations A-D.

TABLE 1
Components of formulations A-D.

| | Formu- | Formu- | Formu- | Formu- |
|---|---|---|---|---|
| | lation A | lation B | lation C | lation D |
| Ingredient | (wt %) | (wt %) | (wt %) | (wt %) |
| Spearmint or peppermint | 1.00 | 1.00 | 0.10 | 0.10 |
| or cornmint oil | | | | |
| Geranium Oil | 1.00 | 1.00 | 1.60 | 1.60 |
| Cinnamon oil | 1.00 | 1.00 | 0.00 | 0.00 |
| Cedarwood oil | 0.00 | 0.00 | 1.00 | 1.00 |
| Water | 77.57 | 74.57 | 77.86 | 74.86 |
| Isopropyl myristate | 10.73 | 10.73 | 10.73 | 10.73 |
| Ethyl lactate or butyl | 6.70 | 6.70 | 6.70 | 6.70 |
| lactate or isopropyl | | | | |
| alcohol | | | | |
| Andean Q ultra or | 1.20 | 1.20 | 1.20 | 1.20 |
| Quillaja saponin | | | | |
| Polyglyceryl oleate | 0.80 | 0.80 | 0.80 | 0.80 |
| Carbon dioxide (CO₂) | 0.00 | 2.85 | 0.00 | 2.85 |

Formulations E, F, G, H, I, J, K, and L are water-based pest control formulations and comprise about 2.5% or about 0.3% spearmint oil; about 2.5% or about 4.5% geranium oil; about 2.5% cinnamon oil; about 2.8% cedarwood oil; about 61% to about 71% water; about 10.7% isopropyl myristate; about 6.7% ethyl lactate; about 6.7% butyl lactate; about 3.7% surfactant; about 0.3% preservative; and about 2.9% of an optional propellant.

The following ingredients in Table 2 are combined to prepare formulations E-H.

TABLE 2
Components of formulations E-H.

| | Formu- | Formu- | Formu- | Formu- |
|---|---|---|---|---|
| | lation E | lation F | lation G | lation H |
| Ingredient | (wt %) | (wt %) | (wt %) | (wt %) |
| Spearmint oil | 2.50 | 2.50 | 2.50 | 2.50 |
| Geranium oil | 2.50 | 2.50 | 2.50 | 2.50 |
| Cinnamon oil | 2.50 | 2.50 | 2.50 | 2.50 |
| Water | 64.00 | 62.00 | 71.00 | 68.00 |
| Isopropyl myristate | 10.73 | 10.73 | 10.73 | 10.73 |
| Ethyl lactate | 6.70 | 6.70 | 6.70 | 6.70 |
| Butyl lactate | 6.70 | 6.70 | 0.00 | 0.00 |
| Sodium lauryl | 2.70 | 2.70 | 2.70 | 2.70 |
| sulfate or sodium | | | | |
| oleate or potassium | | | | |
| oleate or sodium | | | | |
| ricinolate | | | | |
| Glyceryl monooleate | 1.00 | 1.00 | 1.00 | 1.00 |
| Sodium benzoate | 0.30 | 0.30 | 0.30 | 0.30 |
| Carbon dioxide (CO₂) | 0.00 | 2.85 | 0.00 | 2.85 |

The following ingredients in Table 3 are combined to prepare formulations I-L.

TABLE 3
Components of formulations I-L.

| | Formu- | Formu- | Formu- | Formu- |
|---|---|---|---|---|
| | lation I | lation J | lation K | lation L |
| Ingredient | (wt %) | (wt %) | (wt %) | (wt %) |
| Spearmint oil | 0.28% | 0.28% | 0.28% | 0.28% |
| Geranium oil | 4.48% | 4.48% | 4.48% | 4.48% |
| Cedarwood oil | 2.80% | 2.80% | 2.80% | 2.80% |
| Water | 64.00% | 61.00% | 71.00% | 68.00% |
| Isopropyl myristate | 10.73% | 10.73% | 10.73% | 10.73% |
| Ethyl lactate | 6.70% | 6.70% | 6.70% | 6.70% |
| Butyl lactate | 6.70% | 6.70% | 0.00% | 0.00% |
| Sodium lauryl sulfate | 2.70% | 2.70% | 2.70% | 2.70% |
| or sodium oleate or | | | | |
| potassium oleate or | | | | |
| sodium reicinolate | | | | |
| Glyceryl monooleate | 1.00% | 1.00% | 1.00% | 1.00% |
| Sodium benzoate | 0.30% | 0.30% | 0.30% | 0.30% |
| Carbon dioxide (CO₂) | 0.00% | 2.85 | 0.00% | 2.85% |

Formulations M, N, O, and P are water-based pest control formulations and comprise about 8% eugenol; about 68% to about 73% water; about 10.4% isopropyl myristate; about 6.5% ethyl lactate or about 6.5% butyl lactate; about 2.0% or 3.7% surfactant; about 0.3% preservative; and about 2.9% of an optional propellant.

The following ingredients in Table 4 are combined to prepare formulations M-P.

TABLE 4
Components of formulations M-P.

| | Formu- | Formu- | Formu- | Formu- |
|---|---|---|---|---|
| | lation M | lation N | lation O | lation P |
| Ingredient | (wt %) | (wt %) | (wt %) | (wt %) |
| Eugenol | 8.00% | 8.00% | 8.00% | 8.00% |
| Water | 70.25% | 73.10% | 68.25% | 71.10% |
| Isopropyl myristate | 10.40% | 10.40% | 10.40% | 10.40% |
| Ethyl lactate | 0.00% | 0.00% | 6.50% | 6.50% |
| Ethyl lactate or | 6.50% | 6.50% | 0.00% | 0.00% |
| Butyl lactate or | | | | |
| isopropyl alcohol | | | | |
| Andean Q ultra or | 1.20% | 1.20% | 0.00% | 0.00% |
| Quillaja saponin | | | | |
| Polyglyceryl oleate | 0.80% | 0.80% | | |
| Sodium Lauryl | 0.00% | 0.00% | 2.70% | 2.70% |
| Sulfate or Sodium | | | | |
| Oleate or Potassium | | | | |
| Oleate or Sodium | | | | |
| Ricinolate | | | | |
| Glyceryl monooleate | 0.00% | 0.00% | 1.00% | 1.00% |
| Sodium benzoate | 0.00% | 0.00% | 0.30% | 0.30% |
| Carbon dioxide (CO₂) | 2.85% | 0.00% | 2.85 | 0.00% |

The following ingredients in Table 5 are combined to prepare formulations Q-R. Formulation Q is a comparative example of formulations M-P.

TABLE 5
Components of formulations Q and R.

| | Formu- | Formu- |
|---|---|---|
| | lation Q | lation R |
| Ingredient | (wt %) | (wt %) |
| Eugenol | 4.00% | 12.0% |
| Water | 77.10% | 69.1% |
| Isopropyl myristate | 10.40% | 10.4% |
| Ethyl lactate | 6.50% | 6.5% |
| Andean Q ultra, | 1.20% | 1.2% |
| Quillaja saponin, | | |
| or saponin | | |
| Polyglyceryl oleate | 0.80% | 0.80% |

Formulations Q and R were tested according to the premises treatment procedures discussed above. The results are summarized in Table 6 below

TABLE 6
Efficacy data of formulations Q and R.

| | Formu- | Formu- |
|---|---|---|
| Efficacy | lation Q | lation R |
| American cockroach (Periplaneta | 0% | 20% |
| americana) mean % knockdown 30 seconds | | |
| American cockroach (Periplaneta | 0% | 100% |
| americana) mean % mortality 24 hours | | |
| German cockroach (Blattella germanica) | 5% | 20% |
| mean % knockdown 30 seconds | | |
| German cockroach (Blattella germanica) | 75% | 100% |
| mean % mortality 24 hours | | |

### Example 2

In addition to studying the efficacy of several formulations of the present disclosure, the effect of changing the relative amounts of the geranium oil, the at least one mint oil (e.g., spearmint oil, peppermint oil, cornmint oil) and cinnamon oil was also studied. In other words, the effect of altering the ratio of the geranium oil to the at least one mint oil (e.g., spearmint oil, peppermint oil, cornmint oil) and to cinnamon oil was studied. Here, Formulations 1-15 were prepared according to the weight percentages shown in Tables 7-10. To keep other variables constant, the total amount of essential oils were kept constant at 5%, and the other ingredients included in the formulations were also kept constant at 4% sodium lauryl sulfate, 0.5% sodium benzoate, 80.5% water, and 10% isopropyl myristate.

As shown in Tables 7-8, Formulations 1-6 included 5 wt. % total essential oil. Formulation 1 included 5 wt. % geranium oil and Formulation 2 included 5 wt. % spearmint oil. Formulations 3-6 tested ratios between the geranium oil and the mint oil (i.e., spearmint oil, in this embodiment), 20:1 (Formulation 3), 10:1 (Formulation 4), 2:1 (Formulation 5), and 1:1 (Formulation 6).

TABLE 7
Components of Formulations 1-3.

| | Formulation 1 | Formulation 2 | Formulation 3 |
|---|---|---|---|
| Ingredient | (wt. %) | (wt. %) | (wt. %) |
| Geranium Oil | 5.0% | 0.0% | 4.76% |
| Spearmint Oil | 0.0% | 5.0% | 0.24% |
| Cinnamon Oil | 0.0% | 0.0% | 0.0% |
| Sodium Lauryl Sulfate | 4.0% | 4.0% | 4.0% |
| Sodium Benzoate | 0.5% | 0.5% | 0.5% |
| Water | 80.5% | 80.5% | 80.5% |
| Isopropyl Myristate | 10.0% | 10.0% | 10.0% |

TABLE 8
Components of Formulations 4-6.

| | Formu- | Formu- | Formu- |
|---|---|---|---|
| | lation 4 | lation 5 | lation 6 |
| Ingredient | (wt. %) | (wt. %) | (wt. %) |
| Geranium Oil | 4.55% | 3.33% | 2.5% |
| Spearmint Oil | 0.45% | 1.67% | 2.5% |
| Cinnamon Oil | 0.0% | 0.0% | 0.0% |
| Sodium Lauryl Sulfate | 4.0% | 4.0% | 4.0% |
| Sodium Benzoate | 0.5% | 0.5% | 0.5% |
| Water | 80.5% | 80.5% | 80.5% |
| Isopropyl Myristate | 10.0% | 10.0% | 10.0% |

As shown in Table 9 and 10, Formulations 7-9 tested ratios between the geranium oil, the mint oil, and cinnamon oil of 1:10:0 (Formulation 7), and 1:100:0 (Formulation 8), 1:1:1 (Formulation 9), 0:1:1 (Formulation 10), 1:0:1 (Formulation 11), and 0:0:1 (Formulation 12 included 5 wt. % cinnamon oil).

TABLE 9
Components of Formulations 7-9.

| | Formu- | Formu- | Formu- |
|---|---|---|---|
| | lation 7 | lation 8 | lation 9 |
| Ingredient | (wt. %) | (wt. %) | (wt. %) |
| Geranium Oil | 0.45% | 0.05% | 1.667% |
| Spearmint Oil | 4.55% | 4.95% | 1.667% |
| Cinnamon Oil | 0.0% | 0.0% | 1.667% |
| Sodium Lauryl Sulfate | 4.0% | 4.0% | 4.0% |
| Sodium Benzoate | 0.5% | 0.5% | 0.5% |
| Water | 80.5% | 80.5% | 80.5% |
| Isopropyl Myristate | 10.0% | 10.0% | 10.0% |
| Total | 100% | 100% | 100% |

TABLE 10
Components of Formulations 10-12.

| | Formu- | Formu- | Formu- |
|---|---|---|---|
| | lation 10 | lation 11 | lation 12 |
| Ingredient | (wt. %) | (wt. %) | (wt. %) |
| Geranium Oil | 0.0% | 2.5% | 0.0% |
| Spearmint Oil | 2.5% | 0.0% | 0.0% |
| Cinnamon Oil | 2.5% | 2.5% | 5.0% |
| Sodium Lauryl Sulfate | 4.0% | 4.0% | 4.0% |
| Sodium Benzoate | 0.5% | 0.5% | 0.5% |
| Water | 80.5% | 80.5% | 80.5% |
| Isopropyl Myristate | 10.0% | 10.0% | 10.0% |
| Total | 100% | 100% | 100% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 11 below.

As shown in the efficacy data in Table 11, each ratio of geranium oil to mint oil (i.e., spearmint oil, in this embodiment) to cinnamon oil exhibited strong knockdown and strong mortality results for Culex quinquefasciatus. Overall, the treated test systems exhibited 24-hour mean mortality of about 100%, and 30-second knockdown of greater than 90%, and in particular greater than 95%, thereby exhibiting the efficacy of formulations of the present disclosure and the wide range of ratios the geranium oil, the mint oil and the cinnamon oil may be in relative to one another while still providing optimal insecticidal properties.

TABLE 11
Efficacy Data for Formulations 1-12.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 1 | 0.00% | 93.33% | 0.00% | 100.00% |
| 2 | 0.00% | 95.56% | 0.00% | 100.00% |
| 3 | 0.00% | 97.78% | 0.00% | 100.00% |
| 4 | 6.67% | 97.78% | 20.0% | 100.00% |
| 5 | 6.67% | 95.56% | 20.0% | 100.00% |
| 6 | 0.00% | 91.11% | 0.00% | 100.00% |
| 7 | 0.00% | 95.56% | 0.00% | 100.00% |
| 8 | 0.00% | 100.00% | 0.00% | 100.00% |
| 9 | 0.00% | 95.56% | 0.00% | 100.00% |
| 10 | 0.00% | 97.78% | 0.00% | 100.00% |
| 11 | 0.00% | 95.56% | 0.00% | 100.00% |
| 12 | 0.00% | 91.11% | 0.00% | 100.00% |

### Example 3

The effect of changing the total weight percentage of the essential oils, including the geranium oil, the mint oil (e.g., spearmint oil in this embodiment) and cinnamon oil, was also studied. Here, Formulations 13-21 were prepared according to the weight percentages shown in Tables 12 (75% oil, 35% oil, 25% oil, and 15% oil), Table 13 (0.5% oil, 0.004% oil, and 0.003% oil), and Table 14 (0.001% oil, and 0% oil). To keep other variables constant, the ratio of the essential oils to one another was kept constant at 1:1:1 and the other ingredients and their weight percentages were determined based on the weight percentages of the essential oils.

As shown in Table 12, Formulation 13 included 75 wt. % essential oil, Formulation 14 included 35 wt. % essential oil, Formulation 15 included 25 wt. % essential oil, and Formulation 16 included 15 wt. % essential oil.

TABLE 12
Components of Formulations 13-16.

| | Formulation 13 | Formulation 14 | Formulation 15 | Formulation 16 |
|---|---|---|---|---|
| Ingredient | (wt. %) | (wt. %) | (wt. %) | (wt. %) |
| Geranium Oil | 25.0% | 11.7% | 8.3% | 5.0% |
| Spearmint Oil | 25.0% | 11.7% | 8.3% | 5.0% |
| Cinnamon Oil | 25.0% | 11.7% | 8.3% | 5.0% |
| Sodium Lauryl Sulfate | 1.05% | 2.74% | 3.16% | 3.58% |
| Sodium Benzoate | 0.13% | 0.34% | 0.39% | 0.45% |
| Water | 21.18% | 55.08% | 63.55% | 72.03% |
| Isopropyl Myristate | 2.63% | 6.84% | 7.89% | 8.95% |

As shown in Table 13, Formulation 17 included 0.5 wt. % essential oil, Formulation 18 included 0.004 wt. % essential oil, and Formulation 19 included 0.003 wt. % essential oil.

TABLE 13
Components of Formulations 17-19.

| | Formu- | Formu- | Formu- |
|---|---|---|---|
| | lation 17 | lation 18 | lation 19 |
| Ingredient | (wt. %) | (wt. %) | (wt. %) |
| Geranium Oil | 0.1667% | 0.0013% | 0.001% |
| Spearmint Oil | 0.1667% | 0.0013% | 0.001% |
| Cinnamon Oil | 0.1667% | 0.0013% | 0.001% |
| Sodium Lauryl Sulfate | 4.19% | 4.21% | 4.21% |
| Sodium Benzoate | 0.52% | 0.53% | 0.53% |
| Water | 84.31% | 84.73% | 84.73% |
| Isopropyl Myristate | 10.47% | 10.53% | 10.53% |

As shown in Table 14, Formulation 20 included 0.001 wt. % essential oil, and Formulation 21 included 0.0 wt. % essential oil.

TABLE 14
Components of Formulations 20-21.

| | Formulation 20 | Formulation 21 |
|---|---|---|
| Ingredient | (wt. %) | (wt. %) |
| Geranium Oil | 0.0003% | 0.0% |
| Spearmint Oil | 0.0003% | 0.0% |
| Cinnamon Oil | 0.0003% | 0.0% |
| Sodium Lauryl Sulfate | 4.21% | 4.21% |
| Sodium Benzoate | 0.53% | 0.53% |
| Water | 84.74% | 84.74% |
| Isopropyl Myristate | 10.53% | 10.53% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 15 below.

As shown in the efficacy data in Table 15, the formulations exhibited strong knockdown and strong mortality results for all total essential oil percentages tested in the range of between 0.001 wt. % and 75 wt. %. In particular, formulations having essential oils in weight percentages between 0.001 wt. % and 75 wt. % exhibit 24-hour mean mortality of about 100% and 30-second knockdown of greater that 80%, and in particular greater than 86%, thereby exhibiting the efficacy of formulations of the present disclosure and the wide range of total essential oil percentages for providing optimal insecticidal properties.

TABLE 15
Efficacy Data for Formulations 13-21.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 13 | 0.00% | 100.00% | 0.00% | 100.00% |
| 14 | 0.00% | 80.00% | 0.00% | 100.00% |
| 15 | 0.00% | 88.89% | 0.00% | 100.00% |
| 16 | 0.00% | 86.67% | 0.00% | 100.00% |
| 17 | 0.00% | 100.00% | 0.00% | 100.00% |
| 18 | 0.00% | 86.67% | 0.00% | 100.00% |
| 19 | 0.00% | 86.67% | 0.00% | 100.00% |
| 20 | 0.00% | 86.67% | 0.00% | 100.00% |
| 21 | 0.00% | 88.89% | 0.00% | 100.00% |

### Example 4

The effect of changing the total weight percentages of two oils was also studied. In other words, the effect of changing the total weight percentages of essential oils if formulations with two oils (e.g., geranium and spearmint, geranium and cinnamon, and spearmint and cinnamon) was studied. Here, Formulations 22-27 were prepared according to the weight percentages shown in Tables 16-17. To keep other variables constant, the ratio of the essential oils to one another was kept constant at 1:1 and the other ingredients and their weight percentages were determined based on the weight percentages of the essential oils.

As shown in Table 16, Formulation 22 included 75 wt. % essential oil, Formulation 23 included 25 wt. % essential oil, and Formulation 24 included 10 wt. % essential oil. In this case, geranium oil and spearmint oil were used.

TABLE 16
Components of Formulations 30-33.

| | Formu- | Formu- | Formu- |
|---|---|---|---|
| | lation 22 | lation 23 | lation 24 |
| Ingredient | (wt. %) | (wt. %) | (wt. %) |
| Geranium Oil | 37.50% | 12.50% | 5.0% |
| Spearmint Oil | 37.50% | 12.50% | 5.0% |
| Cinnamon Oil | 0.0% | 0.0% | 0.0% |
| Sodium Lauryl Sulfate | 1.05% | 3.16% | 3.79% |
| Sodium Benzoate | 0.13% | 0.39% | 0.47% |
| Water | 19.87% | 59.61% | 71.53% |
| Isopropyl Myristate | 2.63% | 7.89% | 9.47% |
| Eugenol | 1.32% | 3.95% | 4.74% |

As shown in Table 17, Formulation 25 included 0.5 wt. % essential oil, Formulation 26 included 0.004 wt. % essential oil, and Formulation 27 included 0.001 wt. % essential oil. In this case, geranium oil and spearmint oil were used.

TABLE 17
Components of formulations 25-27.

| | Formu- | Formu- | Formu- |
|---|---|---|---|
| | lation 25 | lation 26 | lation 27 |
| Ingredient | (wt. %) | (wt. %) | (wt. %) |
| Geranium Oil | 0.25% | 0.002% | 0.0005% |
| Spearmint Oil | 0.25% | 0.002% | 0.0005% |
| Cinnamon Oil | 0.0% | 0.0% | 0.0% |
| Sodium Lauryl Sulfate | 4.19% | 4.21% | 4.21% |
| Sodium Benzoate | 0.52% | 0.53% | 0.53% |
| Water | 79.08% | 79.471% | 79.473% |
| Isopropyl Myristate | 10.47% | 10.526% | 10.526% |
| Eugenol | 5.24% | 5.263% | 5.263% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 18 below.

As shown in the efficacy data in Table 18, the formulations of two oils, namely, geranium oil and spearmint oil, in a range of weight percentages exhibited strong knockdown and strong mortality results for all total essential oil percentages tested in the range of between 0.001 wt. % and 75 wt. %. In particular, formulations having essential oils in weight percentages between 0.001 wt. % and 75 wt. % exhibit 24-hour mean mortality of about 100% and 30-second knockdown of greater than 93%, and in particular greater than 97%, thereby exhibiting the efficacy of formulations of the present disclosure and the wide range of total essential oil percentages and essential oil combinations for providing optimal insecticidal properties.

TABLE 18
Efficacy data for Formulations 22-27.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 22 | 0.00% | 100.00% | 50.00% | 100.00% |
| 23 | 0.00% | 97.78% | 20.00% | 100.00% |
| 24 | 0.00% | 100.00% | 6.67% | 100.00% |
| 25 | 0.00% | 93.33% | 0.00% | 100.00% |
| 26 | 0.00% | 95.56% | 0.00% | 100.00% |
| 27 | 0.00% | 97.78% | 0.00% | 100.00% |

As shown in Table 19, Formulation 28 included 75 wt. % essential oil, Formulation 29 included 25 wt. % essential oil, and Formulation 30 included 15 wt. % essential oil. In this case, geranium oil and cinnamon oil were used.

TABLE 19
Components of Formulations 28-30.

| | Formu- | Formu- | Formu- |
|---|---|---|---|
| | lation 28 | lation 29 | lation 30 |
| Ingredient | (wt. %) | (wt. %) | (wt. %) |
| Geranium Oil | 37.50% | 12.50% | 7.50% |
| Spearmint Oil | 0.0% | 0.0% | 0.0% |
| Cinnamon Oil | 37.50% | 12.50% | 7.50% |
| Sodium Lauryl Sulfate | 1.05% | 3.16% | 3.58% |
| Sodium Benzoate | 0.13% | 0.39% | 0.45% |
| Water | 19.87% | 59.61% | 67.55% |
| Isopropyl Myristate | 2.63% | 7.89% | 8.95% |
| Eugenol | 1.32% | 3.95% | 4.47% |

As shown in Table 20, Formulation 31 included 0.5 wt. % essential oil, Formulation 32 included 0.004 wt. % essential oil, and Formulation 33 included 0.001 wt. % essential oil. In this case, geranium oil and cinnamon oil were used.

TABLE 20
Components of Formulations 31-33.

| | Formu- | Formu- | Formu- |
|---|---|---|---|
| | lation 31 | lation 32 | lation 33 |
| Ingredient | (wt. %) | (wt. %) | (wt. %) |
| Geranium Oil | 0.25% | 0.002% | 0.0005% |
| Spearmint Oil | 0.0% | 0.0% | 0.0% |
| Cinnamon Oil | 0.25% | 0.002% | 0.0005% |
| Sodium Lauryl Sulfate | 4.19% | 4.21% | 4.21% |
| Sodium Benzoate | 0.52% | 0.53% | 0.53% |
| Water | 79.08% | 79.471% | 79.473% |
| Isopropyl Myristate | 10.47% | 10.526% | 10.526% |
| Eugenol | 5.24% | 5.263% | 5.263% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 24 below.

As shown in the efficacy data in Table 21, the formulations of two oils, namely, geranium oil and cinnamon oil, in a range of weight percentages exhibited strong knockdown and strong mortality results for all total essential oil percentages tested in the range of between 0.001 wt. % and 75 wt. %. In particular, formulations having essential oils in weight percentages between 0.001 wt. % and 75 wt. % exhibit 24-hour mean mortality of about 100% and 30-second knockdown of greater than 91%, and in particular greater than 97%, thereby exhibiting the efficacy of formulations of the present disclosure and the wide range of total essential oil percentages and essential oil combinations for providing optimal insecticidal properties.

TABLE 21
Efficacy Data for Formulations 28-33.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 28 | 93.33% | 100.00% | 100% | 100.00% |
| 29 | 0.00% | 93.33% | 0.00% | 100.00% |
| 30 | 0.00% | 100.00% | 33.33% | 100.00% |
| 31 | 0.00% | 97.78% | 26.67% | 100.00% |
| 32 | 0.00% | 91.11% | 0.00% | 100.00% |
| 33 | 10.00% | 97.78% | 43.33% | 100.00% |

As shown in Table 22, Formulation 34 included 75 wt. % essential oil, Formulation 35 included 25 wt. % essential oil, and Formulation 36 included 15 wt. % essential oil. In this case, spearmint oil and cinnamon oil were used.

TABLE 22
Components of Formulations 34-36.

| | Formu- | Formu- | Formu- |
|---|---|---|---|
| | lation 34 | lation 35 | lation 36 |
| Ingredient | (wt. %) | (wt. %) | (wt. %) |
| Geranium Oil | 0.0% | 0.0% | 0.0% |
| Spearmint Oil | 37.50% | 12.50% | 7.50% |
| Cinnamon Oil | 37.50% | 12.50% | 7.50% |
| Sodium Lauryl Sulfate | 1.05% | 3.16% | 3.58% |
| Sodium Benzoate | 0.13% | 0.39% | 0.45% |
| Water | 19.87% | 59.61% | 67.55% |
| Isopropyl Myristate | 2.63% | 7.89% | 8.95% |
| Eugenol | 1.32% | 3.95% | 4.47% |

As shown in Table 23, Formulation 37 included 0.5 wt. % essential oil, Formulation 38 included 0.004 wt. % essential oil, and Formulation 39 included 0.001 wt. % essential oil. In this case, spearmint oil and cinnamon oil were used.

TABLE 23
Components of Formulations 37-39.

| | Formu- | Formu- | Formu- |
|---|---|---|---|
| | lation 37 | lation 38 | lation 39 |
| Ingredient | (wt. %) | (wt. %) | (wt. %) |
| Geranium Oil | 0.0% | 0.0% | 0.0% |
| Spearmint Oil | 0.25% | 0.002% | 0.0005% |
| Cinnamon Oil | 0.25% | 0.002% | 0.0005% |
| Sodium Lauryl | 4.19% | 4.21% | 4.21% |
| Sulfate | | | |
| Sodium Benzoate | 0.52% | 0.53% | 0.53% |
| Water | 79.08% | 79.471% | 79.473% |
| Isopropyl | 10.47% | 10.526% | 10.526% |
| Myristate | | | |
| Eugenol | 5.24% | 5.263% | 5.263% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 24 below.

As shown in the efficacy data in Table 24, the formulations of two oils, namely, spearmint oil and cinnamon oil, in a range of weight percentages exhibited strong knockdown and strong mortality results for all total essential oil percentages tested in the range of between 0.001 wt. % and 75 wt. %. In particular, formulations having essential oils in weight percentages between 0.001 wt. % and 75 wt. % exhibit 24-hour mean mortality of about 100% and 30-second knockdown of greater than 95%, and in particular greater than 97%, thereby exhibiting the efficacy of formulations of the present disclosure and the wide range of total essential oil percentages and essential oil combinations for providing optimal insecticidal properties.

TABLE 24
Efficacy Data for Formulations 34-39.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 34 | 0.00% | 97.78% | 76.67% | 100.00% |
| 35 | 0.00% | 95.56% | 0.00% | 100.00% |
| 36 | 0.00% | 100.00% | 0.00% | 100.00% |
| 37 | 0.00% | 95.56% | 0.00% | 100.00% |
| 38 | 0.00% | 97.78% | 0.00% | 100.00% |
| 39 | 0.00% | 97.78% | 30.00% | 100.00% |

### Example 5

The effect of changing the type of essential oil used in the formulations or compositions was also studied. Here, Formulations 40-43 were prepared according to the weight percentages shown in Table 25 using eugenol 5% with 5% clove oil (Formulation 40), 5% elemi oil (Formulation 41), 5% castor oil (Formulation 42), and 5% geraniol (Formulation 43). To keep other variables constant, only one essential oil was used per formulation and the other ingredients remained constant, where the formulations included 4.00 wt. % sodium lauryl sulfate, 0.50 wt. % sodium benzoate, 75.50 wt. % water, and 10.00 wt. % isopropyl myristate.

TABLE 25
Components of Formulations 40-43.

| | Formu- | Formu- | Formu- | Formu- |
|---|---|---|---|---|
| | lation 40 | lation 42 | lation 43 | lation 44 |
| Ingredient | (wt. %) | (wt. %) | (wt. %) | (wt. %) |
| Eugenol | 5.00% | 5.00% | 5.00% | 5.00% |
| Clove Oil | 5.00% | 0.00% | 0.00% | 0.00% |
| Elemi Oil | 0.00% | 5.00% | 0.00% | 0.00% |
| Castor Oil | 0.00% | 0.00% | 5.00% | 0.00% |
| Geraniol Oil | 0.00% | 0.00% | 0.00% | 5.00% |
| Sodium Lauryl | 4.00% | 4.00% | 4.00% | 4.00% |
| Sulfate | | | | |
| Sodium | 0.50% | 0.50% | 0.50% | 0.50% |
| Benzoate | | | | |
| Water | 75.50% | 75.50% | 75.50% | 75.50% |
| Isopropyl | 10.00% | 10.00% | 10.00% | 10.00% |
| Myristate | | | | |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 26 below.

As shown in the efficacy data in Table 26, formulations including other oils, namely clove oil, elemi oil, castor oil, and geraniol, exhibited 30-second knockdown and 24-hour mean mortality data of 100% for Culex quinquefasciatus, comparable to formulations prepared according to an embodiment of the present disclosure including mint oil, geranium oil, and/or cinnamon oil.

TABLE 26
Efficacy Data for Formulations 40-43.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 40 | 0.00% | 100.00% | 0.00% | 100.00% |
| 41 | 0.00% | 100.00% | 0.00% | 100.00% |
| 42 | 0.00% | 100.00% | 40.00% | 100.00% |
| 43 | 23.33% | 100.00% | 43.33% | 100.00% |

### Example 6

The effect of changing the weight percentages of solvent was also studied, in this case, isopropyl alcohol. For this study and example, Formulations 44-48 were prepared according to the weight percentages shown in Tables 27-28. To keep other variables constant, the weight percentage and ratio of the geranium oil, the mint oil, and the cinnamon oil was kept constant at 1:1:1 and 1.667 wt. % each.

TABLE 27
Components of Formulations 44-46.

| | Formu- | Formu- | Formu- |
|---|---|---|---|
| | lation 44 | lation 45 | lation 46 |
| Ingredient | (wt. %) | (wt. %) | (wt. %) |
| Geranium Oil | 1.667% | 1.667% | 1.667% |
| Spearmint Oil | 1.667% | 1.667% | 1.667% |
| Cinnamon Oil | 1.667% | 1.667% | 1.667% |
| Water | 94.5% | 90.0% | 80.0% |
| Isopropyl Alcohol | 0.5% | 5.0% | 15.0% |

TABLE 28
Components of Formulations 47 and 48.

| | Formulation 47 | Formulation 48 |
|---|---|---|
| Ingredient | (wt. %) | (wt. %) |
| Geranium Oil | 1.667% | 1.667% |
| Spearmint Oil | 1.667% | 1.667% |
| Cinnamon Oil | 1.667% | 1.667% |
| Water | 65% | 20% |
| Isopropyl Alcohol | 30.0% | 75.0% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 29 below.

As shown in the efficacy data in Table 29, formulations changing the weight percentages of solvent, exhibited 30-second knockdown of greater than 73% and 24-hour mean mortality data of 100%, comparable to formulations prepared according to an embodiment of the present disclosure.

TABLE 29
Efficacy Data for Formulations 44-48.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 44 | 0.00% | 73.33% | 23.33% | 100.00% |
| 45 | 60.00% | 100.00% | 73.33% | 100.00% |
| 46 | 56.67% | 97.78% | 90.00% | 100.00% |
| 47 | 100.00% | 95.56% | 100.00% | 100.00% |
| 48 | 100.00% | 97.78% | 100.00% | 100.00% |

### Example 7

The effect of changing the weight percentage of eugenol was also studied. For this study and example, Formulations 49-53 were prepared according to the weight percentages shown in Table 30. The weight percent of eugenol was tested at 0.03% (Formulation 49), 3.0% (Formulation 50), 7.5% (Formulation 51), 15% (Formulation 52) and 50% (Formulation 53). To keep other variables constant, the weight percentage and ratio of the geranium oil, the mint oil, and the cinnamon oil was kept constant at 1:1:1 and 1.667 wt. % each.

TABLE 30
Components of Formulations 49-53.

| | Formulation 49 | Formulation 50 | Formulation 51 | Formulation 52 | Formulation 53 |
|---|---|---|---|---|---|
| Ingredient | (wt. %) | (wt. %) | (wt. %) | (wt. %) | (wt. %) |
| Geranium Oil | 1.667% | 1.667% | 1.667% | 1.667% | 1.667% |
| Spearmint Oil | 1.667% | 1.667% | 1.667% | 1.667% | 1.667% |
| Cinnamon Oil | 1.667% | 1.667% | 1.667% | 1.667% | 1.667% |
| Water | 94.97% | 92.0% | 87.5% | 80.0% | 45.0% |
| Eugenol | 0.3% | 3.0% | 7.5% | 15.0% | 50.0% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 31 below.

As shown in the efficacy data in Table 31, changing the weight percentage of eugenol between 0.3% and 50% with 5% total essential oil exhibited inferior 30-second knockdown for both species, in particular between 53% and 97%. The 24-hour mean mortality data of ranged between 60% and 100%, comparable to formulations prepared according to an embodiment of the present disclosure.

The test results of the present example show there is little correlation between the amount of eugenol present and the knockdown and mortality results, other than somewhat positive correlation at very high amounts of eugenol in the mortality data. The data for this case show the improved efficacy in knockdown and mortality of the formulations of the present disclosure is not simply attributable to eugenol and their concentration in the formulation, but rather attributable to the synergy of the combination of essential oils and other active components present in formulations of the present disclosure.

TABLE 31
Efficacy Data for Formulations 49-53.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 49 | 0.00% | 53.33% | 0.00% | 60.00% |
| 50 | 30.00% | 80.00% | 40.00% | 86.67% |
| 51 | 40.00% | 60.00% | 56.67% | 100.00% |
| 52 | 0.00% | 62.22% | 60.00% | 100.00% |
| 53 | 0.00% | 97.78% | 100.00% | 100.00% |

### Example 8

The effect of changing the weight percentage of preservative (e.g., sodium benzoate) was also studied. For this study and example, Formulations 54-58 were prepared according to the weight percentages shown in Table 32. The weight percent of sodium benzoate was tested at 0.01% (Formulation 54), 0.1% (Formulation 55), 0.3% (Formulation 56), 0.5% (Formulation 57) and 5.0% (Formulation 58). To keep other variables constant, the weight percentage and ratio of the geranium oil, the mint oil, and the cinnamon oil was kept constant at 1:1:1 and 1.667 wt. % each.

TABLE 32
Components of Formulations 54-58.

| | Formulation 54 | Formulation 55 | Formulation 56 | Formulation 57 | Formulation 58 |
|---|---|---|---|---|---|
| Ingredient | (wt. %) | (wt. %) | (wt. %) | (wt. %) | (wt. %) |
| Geranium Oil | 1.667% | 1.667% | 1.667% | 1.667% | 1.667% |
| Spearmint Oil | 1.667% | 1.667% | 1.667% | 1.667% | 1.667% |
| Cinnamon Oil | 1.667% | 1.667% | 1.667% | 1.667% | 1.667% |
| Water | 94.99% | 94.9% | 94.7% | 94.5% | 90.0% |
| Sodium Benzoate | 0.01% | 0.1% | 0.3% | 0.5% | 5.0% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 33 below.

As shown in the efficacy data in Table 33, there is little correlation between the amount of preservative present and the knockdown and mortality results. The data showcase the improved efficacy in knockdown and mortality of the formulations of the present disclosure is not simply attributable to the preservative and their concentration in the formulation, but rather attributable to the synergy of the combination of essential oils and other active components present in formulations of the present disclosure.

TABLE 33
Efficacy Data for Formulations 54-58.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 54 | 0.00% | 20.00% | 0.00% | 20.00% |
| 55 | 0.00% | 40.00% | 0.00% | 40.00% |
| 56 | 0.00% | 31.11% | 0.00% | 35.56% |
| 57 | 0.00% | 42.22% | 0.00% | 42.22% |
| 58 | 23.33% | 26.67% | 26.67% | 26.67% |

### Example 9

The effect of changing the weight percentage of surfactant (e.g., glycerol monooleate) was also studied in the range of 0.1-50 wt. %. For this study and example, Formulations 59-63 were prepared according to the weight percentages shown in Table 34. The weight percent of glycerol monooleate was tested at 0.01% (Formulation 59), 0.1% (Formulation 60), 2.5% (Formulation 61), 5.0% (Formulation 62) and 50.0% (Formulation 63). To keep other variables constant, the weight percentage and ratio of the geranium oil, the mint oil, and the cinnamon oil was kept constant at 1:1:1 and 1.667 wt. % each.

TABLE 34
Components of Formulations 100-104.

| | Formulation 59 | Formulation 60 | Formulation 61 | Formulation 62 | Formulation 63 |
|---|---|---|---|---|---|
| Ingredient | (wt. %) | (wt. %) | (wt. %) | (wt. %) | (wt. %) |
| Geranium Oil | 1.667% | 1.667% | 1.667% | 1.667% | 1.667% |
| Spearmint Oil | 1.667% | 1.667% | 1.667% | 1.667% | 1.667% |
| Cinnamon Oil | 1.667% | 1.667% | 1.667% | 1.667% | 1.667% |
| Water | 94.99% | 94.9% | 92.5% | 90.0% | 45.0% |
| Glycerol Monooleate | 0.01% | 0.1% | 2.5% | 5.0% | 50.0% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 35 below.

As shown in the efficacy data in Table 35, the test results of the present example show there is little correlation between the amount of surfactant present and the knockdown and mortality results, other than a slight positive correlation at very high amounts of surfactant in the knockdown and mortality data for Culex quinquefasciatus. The data for this case show the improved efficacy in knockdown and mortality of the formulations of the present disclosure is not simply attributable to eugenol and their concentration in the formulation, but rather attributable to the synergy of the combination of essential oils and other active components present in formulations of the present disclosure.

TABLE 35
Efficacy Data for Formulations 59-63.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 59 | 0.00% | 31.11% | 0.00% | 31.11% |
| 60 | 0.00% | 40.00% | 0.00% | 31.11% |
| 61 | 0.00% | 57.78% | 0.00% | 57.78% |
| 62 | 0.00% | 60.00% | 0.00% | 64.44% |
| 63 | 0.00% | 73.33% | 0.00% | 100.00% |

### Example 10

The effect of changing the weight percentage of propellant (e.g., nitrogen, carbon dioxide) was also studied in the range of 0.05-1 wt. %. For this study and example, Formulations 64-66 were prepared according to the weight percentages shown in Tables 36. The weight percent of nitrogen was tested at 0.05% (Formulation 64), 0.08% (Formulation 65), and 1.0% (Formulation 66). To keep other variables constant, the weight percentage and ratio of the geranium oil, the mint oil, and the cinnamon oil was kept constant at 1:1:1 and 1.667 wt. % each.

TABLE 36
Components of Formulations 64-66.

| | Formulation 64 | Formulation 65 | Formulation 66 |
|---|---|---|---|
| Ingredient | (wt. %) | (wt. %) | (wt. %) |
| Geranium Oil | 1.667% | 1.667% | 1.667% |
| Spearmint Oil | 1.667% | 1.667% | 1.667% |
| Cinnamon Oil | 1.667% | 1.667% | 1.667% |
| Water | 94.95% | 94.92% | 94.0% |
| Nitrogen | 0.05% | 0.08% | 1.0% |

The efficacy data, including the knockdown percentage (after 30 seconds) and mortality percentages (after 24 hours), was observed for one flying insect (Culex quinquefasciatus) and one crawling insect (Blattella germanica). The results from the efficacy tests are provided in Table 37 below.

As shown in the efficacy data in Table 37, the testing results showcase optimal propellant amounts that may be used in combination with the formulations of the present disclosure, if an aerosol formulation is desired. Although this testing was only performed for nitrogen, it should be understood that other propellants, including but not limited to, carbon dioxide or LPG, for example, may also be used in combination with the formulations of the present disclosure.

TABLE 37
Efficacy Data for Formulations 64-66.

| | German cockroach | | German cockroach | |
|---|---|---|---|---|
| | (Blattella | Mosquito (Culex | (Blattella | Mosquito (Culex |
| | germanica) | quinquefasciatus) | germanica) | quinquefasciatus) |
| | mean % knockdown | mean % knockdown | mean % mortality | mean % mortality |
| Formulation | 30 seconds | 30 seconds | 24 hours | 24 hours |
| 64 | 0.00% | 100.00% | 0.00% | 100.00% |
| 65 | 0.00% | 100.00% | 36.67% | 100.00% |
| 66 | 33.33% | 100.00% | 56.67% | 100.00% |

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the disclosure and to teach the best mode of carrying out same. The exclusive rights to all modifications which come within the scope of the appended claims are reserved.

Uwe claim:

1. A pest control composition, the composition comprising:
an active component consisting essentially of:
a) between about 0.001 wt. % and about 10 wt. % of spearmint oil;
b) between about 0.01 wt. % and about 10 wt. % of geranium oil;
c) between about 0.01 wt. % and about 10 wt. % of an oil selected from the group consisting of cinnamon oil, cedarwood oil, and mixtures thereof;
a solvent;
a carrier; and
a surfactant,
wherein all weight percentages are percent by weight of the total composition.

2. The composition of claim 1, wherein a weight ratio of geranium oil to spearmint oil is from about 0.5:1 to about 20:1.

3. The composition of claim 2, wherein the weight ratio of geranium oil to spearmint oil is from about 0.8:1 to about 18:1.

4. The composition of claim 3, wherein the weight ratio of geranium oil to spearmint oil is from about 1:1 to about 16:1.

5. The composition of claim 1, wherein the solvent comprises at least one of ethyl lactate, butyl lactate, isopropyl alcohol, isopropyl myristate, and combinations thereof.

6. The composition of claim 1, wherein the carrier is water.

7. The composition of claim 1, wherein the surfactant is selected from the group consisting essentially of lecithin, sodium lauryl sulfate, sodium oleate, potassium oleate, sodium ricinolate, Quillaja saponin, polyglyceryl oleate, glyceryl monooleate, and any combinations thereof.

8. The composition of claim 1 wherein the composition comprises between 15% and about 30% by weight of the solvent; between 55 wt. % and about 85 wt. % of the carrier; between about 1 wt. % and about 4.5 wt. % of the surfactant; between about 1% to about 5% of a propellant and between about 0.1% to about 0.5% by weight of a preservative.

9. The composition of claim 8, wherein the propellant is selected from the group consisting of compressed gas propellants, liquified gas propellants, saturated hydrocarbons, mixtures of liquified and compressed gas, methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof.

10. The composition of claim 1 wherein the mint oil is in a higher weight percentage concentration than the geranium oil.

11. A pest control composition, the composition comprising:
an active component consisting essentially of:
a) between about 0.001 wt. % and about 10 wt. % of at least one mint oil;
b) between about 0.01 wt. % and about 10 wt. % of geranium oil;
c) between about 0.01 wt. % and about 10 wt. % of cinnamon oil;
a carrier;
a solvent; and
a surfactant.

12. The composition of claim 11, wherein the mint oil is selected from the group consisting of spearmint oil, peppermint oil, cornmint oil, and combinations thereof.

13. The composition of claim 12 wherein the composition comprises between 15% and about 30% by weight of the solvent; between 55 wt. % and about 85 wt. % of the carrier; between about 1 wt. % and about 4.5 wt. % of the surfactant; between about 1% to about 5% of a propellant and between about 0.1% to about 0.5% by weight of a preservative.

14. The composition of claim 12, wherein the weight ratio of geranium oil to mint oil is from about 0.5:1 to about 20:1.

15. The composition of claim 12, wherein the carrier comprises water.

16. The composition of claim 13, wherein the solvent is selected from the group consisting of ethyl lactate, butyl lactate, isopropyl alcohol, isopropyl myristate, and combinations thereof.

17. The composition of claim 16, wherein the surfactant is selected from the group consisting of lecithin, sodium lauryl sulfate, sodium oleate, potassium oleate, sodium ricinolate, Quillaja saponin, polyglyceryl oleate, glyceryl monooleate, and any combinations thereof.

18. The composition of claim 17, wherein the mint oil is spearmint oil.

19. The composition of claim 15, wherein the propellant is selected from the group consisting of compressed gas propellants, liquified gas propellants, saturated hydrocarbons, mixtures of liquified gas and compressed gas, methane ethane, propane, pentane, isobutene, n-butane, isobutane, dimethyl ether, 1, 1-difluoroethane, 1,1,1,2-tetrafluoroethane, carbon dioxide, nitrogen, air, and any combinations thereof.

20. A pest control composition, the composition comprising:
an active component consisting of:
a) between about 0.001 wt. % and about 5 wt. % of a mint oil selected from the group consisting of spearmint oil, cornmint oil, and mixtures thereof;
b) between about 0.01 wt. % and about 5 wt. % geranium oil; and
c) between about 0 wt. % to about 5 wt. % of an oil selected from the group consisting of cinnamon oil, cedarwood oil, and mixtures thereof;
about 55 wt. % to about 86 wt. % of water;
about 3 wt. % to about 15 wt. % at least one solvent;
about 1 wt. % to about 5 wt. % of at least one surfactant; and
about 1 wt. % to about 5 wt. % of at least one propellant,
wherein a weight ratio of geranium oil to mint oil is from about 0.5:1 to about 20:1,
wherein all weight percentages are percent by weight of the total composition.
